(19) United States
(12) Patent Application Publication
(10) Pub. No.: US 2020/0049327 A1
(43) Pub. Date: Feb. 13, 2020

(54) LIGHTING DEVICE, LIGHTING DEVICE ELEMENT, AND PROCESSES FOR THE PRODUCTION THEREOF

(71) Applicant: SIGNIFY HOLDING B.V., EINDHOVEN (NL)

(72) Inventors: ANDREAS ALOYSLUS HENRICUS DUIJMELINK, EINDHOVEN (NL); MARK JOHANNES ANTONIUS VERHOEVEN, DEURNE (NL)

(21) Appl. No.: 16/343,020

(22) PCT Filed: Nov. 3, 2017
(86) PCT No.: PCT/EP2017/078121

§ 371 Date: Apr. 18, 2019

(30) Foreign Application Priority Data
Nov. 15, 2016 (EP) 16198833.2

(51) Int. Cl. F21V 17/10; F21V 19/02; F21V 29/71; F21V 7/22; F21V 15/01

(52) U.S. Cl. CPC F21V 17/101; F21V 19/02; F21V 15/013; F21V 7/22; F21V 29/713

(57) ABSTRACT

The invention provides a lighting device element (100) comprising (i) at least one shaped element (120) selected from the group consisting of a pipe-like shaped element (120,119) and a rod-like shaped element (120,129), (ii) one or more functional elements (180) selected from the group consisting of a light source (10), electronics (20) for a light source (10), a heat sink (1401) and optics (30) for a light source (10), and (iii) a support (140) for the one or more functional element (180), wherein the lighting device element comprises at least said optics as functional element, wherein the lighting device element (100) comprises at least two monolithic bodies (170), each monolithic body (170) comprising at least part of the support (140) and at least part of the optics (30), with said at least two monolithic bodies (170) providing thereby said support (140) and said optics (30), wherein (a1) at least part of the support (140) and (a2) at least part of the one or more functional elements (180) are accommodated within and/or around the shaped element (120); wherein the support (140) and the one or more functional elements (180) are coupled; wherein (b1) the support (140) comprises at least part of a fastening material (145) and/or (b2) a support assist (160), at least partly configured within and/or around the shaped element (120), comprises at least part of the fastening material (145) and the support assist (160) comprises a receptor opening (169) hosting at least part of the support (140); wherein adjacent to a shaped element wall (121) of the shaped element (120) the fastening material (145) comprises (c1) an indentation (147) and (c2) part of the fastening material (145) is in pressed physical contact with said shaped element wall (121) and/or protruding into said shaped element wall (121) via which the support (140) is locally fixed to the shaped element (120).

### FIELD OF THE INVENTION

The invention relates to a lighting device and a lighting device element (for such lighting device). The invention further relates to a process for the production of such lighting device element and to a process for the production of such lighting device (comprising such lighting device element).

### BACKGROUND OF THE INVENTION

Light emitting devices with an adjustable location of the light emitting elements are known in the art. US20080192493, for instance, describes a solid state light emitting apparatus method wherein one or more solid state light emitting elements are mounted on a hardcoat anodized aluminum substrate. One or more bars also may be provided that slidably contact an edge of the hardcoat anodized aluminum substrate. The substrate and the bar(s) may be mounted in a housing with the bars mounted in apertures in the housing wall. Assembling methods for solid state light emitting apparatus also are described.

US 2008/0123340 A1, e.g., describes a light device having a light source, lenses adjacent to the light source, a housing for securing the light source and the lenses, and a light fixture for securing the housing. The light source includes high efficiency light emitting diodes (LEDs), driver circuitry, and a heat sink mounted and integrated on a common board. Lenses magnify and focus light emitting from the LEDs at a diffusion angle between 10° and 100°. The housing comprises a first and a second portion fittable together (e.g., threads, screws and openings).

### SUMMARY OF THE INVENTION

In (fashion) retail lighting the store design is a very important aspect to communicate the brand identity. To prevent cluttering of the design concept, unobtrusive lighting solutions appear to be very important. For track spots this may often mean a small spot design with a neutral shape, of which a cylinder shape appears to be an acceptable standard.

Customization appears to be a typical characteristic of the retail market for spots. A lot of specific designs are engineered in order to make a specific design for a specific customer. In this process it is very important to be able to respond with speed. This often leads to difficulties when designs require investments for tooling in time and money. Often this time is not available. Therefore, there is clear need for low cost flexible tooling to create a large diversity of spot designs. Amongst others, it is herein a desire to provide a heatsink that is flexible in diameter, length, and shape, is able to give a good thermal performance, and that can be made very fast and with only little investments and may have a large area/volume (weight) ratio.

The invention aims at a flexible process to fasten a (functional) part in a shaped element, such as a pipe-like shaped element in a relative simple way. Especially, the invention aims at a method to fix two parts to create one part having a thermal path through these parts and having a mechanical fixation between the parts. Even more especially, the invention relates to a functional integration of parts. Especially, such (functional) part may comprise a combination of a support function (for a light source and/or other lighting device elements, such as electronics for a light source), a heat transport/heat sink function, and an optical function, such as a lens function or reflection function.

An option to fit a (round) plate into an opening could be press fitting. A typical characteristic of this process is that the part that is fitted into the opening is larger than the opening itself, resulting in a pressure fit, when pressed in. However, this method appears to provide mechanical disadvantages.

Another way of fixing a plate, such as a heat-spreader in a tube, could be the heating of the tube, the cooling of the heat-spreader, and then bringing the two together where shrinkage and expansion come to a final state where the heat spreader is clamped in the tube. This process requires a (circular) plate (heat-spreader) that is bigger (especially having a larger cross-sectional area) than the tube cross-sectional area (diameter) and availability of very high and very low temperatures and accurate assembly methods in bringing the parts together. Heating up or cooling down typically requires longer production times and cannot be used when electronic parts like LEDs are already mounted to one of the parts. It is also common practice that optics is arranged after assembling a base and other parts of a lighting device. Further, prior art optics may especially comprise non heat-conductive materials.

Hence, it is an aspect of the invention to provide an alternative process for the production of a lighting device element comprising two parts, especially a housing and a part at least partly integrated in the housing, especially a heat sink, and especially (also) comprising optics for a light source, especially optics that may optionally also comprise a heat sink function, which process preferably further at least partly obviates one or more of above-described drawbacks. It is especially an aspect of the invention to provide functional integration into parts of a lighting device element. It is also an aspect of the invention to provide an alternative process for production of a lighting device, comprising such lighting device element, which preferably further at least partly obviates one or more of above-described drawbacks. Further, it is an aspect of the invention to provide an alternative lighting device and/or lighting device element per se (that may be obtainable with the herein described processes, respectively).

The proposed solution in this invention is based on a housing of tubular or other shape, a support (that may e.g. function as a heat-spreader) with typically a smaller dimension compared to the inner dimension of the housing. The proposed solution is especially based on function integration. A specific solution in this invention is for instance based on a housing of tubular or other shape, and at least two monolithic bodies that (the at least two monolithic bodies together) provide (a combination of) a support (that may e.g. function as a heat-spreader) with typically a smaller dimension compared to the inner dimension of the housing and optics for a light source (that may e.g. also function as a heat sink). Applying local pressure on the support (heat-spreader) may push material outwards, whereby the support may be fastened to the housing.

Hence, in a first aspect the invention provides a process for the production of a lighting device element (“device element”), the lighting device element comprising (i) at least one shaped element selected from the group consisting of a pipe-like shaped element and a rod-like shaped element (herein both types may be referred to as “shaped element”) and (ii) one or more functional elements selected from the group consisting of a light source, electronics for a light source, a heat sink, and optics for a light source, and (iii) a support for the one or more functional elements, the process comprising an arranging stage, the arranging stage comprising: arranging in and/or around the shaped element (a1) at least part of a support for the one or more functional element, and (a2) at least part of the one or more functional element, fastening the support to at least part of the shaped element by pressing with a pressing element a (deformable) fastening material against and/or into a shaped element wall of the shaped element; and especially coupling the one or more functional elements and the support; wherein (b1) the support comprises at least part of the (deformable) fastening material and/or (b2) a support assist, at least partly configured within or around the shaped element, comprises at least part of the (deformable) fastening material and the support assist comprises a receptor opening configured to receive at least part of the support. Especially the lighting device element at least comprises said optics.

In a further aspect, see further also below, the invention also provides such lighting device element per se, i.e. a lighting device element comprising (i) at least one shaped element selected from the group consisting of a pipe-like shaped element and a rod-like shaped element, (ii) one or more functional elements selected from the group consisting of a light source, electronics for a light source, a heat sink and optics for a light source, and (iii) a support for the one or more functional elements, wherein (a1) at least part of the support and (a2) at least part of the one or more functional elements are accommodated within and/or around the shaped element; wherein the support and the one or more functional element are coupled; wherein (b1) the support comprises at least part of a (deformable) fastening material and/or (b2) a support assist, at least partly configured within and/or around the shaped element, comprises at least part of the (deformable) fastening material and the support assist comprises a receptor opening hosting at least part of the support; wherein adjacent to a shaped element wall of the shaped element the (deformable) fastening material comprises (c1) an indentation and (c2) part of the (deformable) fastening material is in pressed physical contact with said shaped element wall and/or protruding into said shaped element wall, especially via which the support is (especially locally) fixed to the shaped element. Especially, such lighting device element is assembled according to the process described herein.

In embodiments (of the process for the production of a lighting device element, and/or of the lighting device element), the lighting device element comprises at least two monolithic bodies, each monolithic body comprising at least part of the support and at least part of the optics, with said at least two monolithic bodies providing thereby said support and said optics. Especially, said at least two monolithic bodies provide a “combined support and optics body”. Especially, the support comprises a support of at least two monolithic bodies. Especially in such embodiments, the lighting device comprises at least the optics as functional element. Hence, the combination of support and optics essentially consists of at least two monolithic bodies.

Especially, to provide such lighting device (element) embodiments, in embodiments, the arranging stage especially comprises arranging in and/or around the shaped element (a1) at least part of the support of said at least two monolithic bodies, fastening the support to at least part of the shaped element by pressing with a pressing element a fastening material against and/or into a shaped element wall of the shaped element; and especially coupling one or more optional functional elements other than the optics and the support.

The optics for the light source, especially provided by at least two monolithic bodies, may have a smaller dimension, a comparable dimension and/or larger dimension compared to the inner housing. Especially, such optics may at least be partly be encompassed by the housing.

In yet another aspect, see also further below, the invention also provides a process for the production of a lighting device, especially a lighting device comprising one or more lighting device elements as described herein. In yet a further aspect (see also further below), the invention also provides such lighting device per se, especially assembled according to the process as (also) described herein.

Hence, in an aspect the invention provides a process for the production of a lighting device element. In embodiments, the lighting device element comprises (i) at least one shaped element selected from the group consisting of a pipe-like shaped element and a rod-like shaped element, (ii) one or more functional elements selected from the group consisting of a light source, electronics for a light source, a heat sink, and optics for a light source, and (iii) a support for the one or more functional elements, wherein the lighting device comprises at least said optics as functional element, wherein the lighting device element comprises at least two monolithic bodies, each monolithic body comprising at least part of a support and at least part of the optics, with said at least two monolithic bodies providing thereby said support and said optics, the process comprising an arranging stage, the arranging stage comprising: arranging in and/or around the shaped element (a1) at least part of the support of said at least two monolithic bodies, fastening the support to at least part of the shaped element by pressing with a pressing element a fastening material against and/or into a shaped element wall of the shaped element; and coupling (especially functionally coupling) one or more optional functional elements other than the optics and the support; wherein (b1) the support comprises at least part of the fastening material and/or (b2) a support assist, at least partly configured within or around the shaped element, comprises at least part of the fastening material and the support assist comprises a receptor opening configured to receive at least part of the support.

In the arranging stage (at least part of) the support is fastened to the shaped element, especially the shaped element wall. Additionally, one or more optional functional elements other than the optics may be coupled to the support the arranging stage. In embodiments, said coupling is provided prior to fastening the support (to the shaped element). In further embodiments, said coupling is provided after fastening the support. Especially said coupling may be provided before and/or during, and/or after fastening (at least part of) the support to the shaped element, see also below.

With the lighting device (element) and the processes for production according to the invention, flexibility in dimensions and arrangements is obtained. The dimensions of the shaped element, like one or more of length, width, height, and e.g. an inner and/or outer diameter (or cross-section) of the shaped element, can be customized. The length of the lighting device (element) according to the invention may be selected; the location of the support may be selected (providing e.g. flexibility in selecting the type of light source, the optics, etc.) but in particular may be located inside a pipe-like shaped element and/or around a rod-like shaped element where at least locally and in its direct vicinity an inner diameter of the pipe-like shaped element is constant and/or an outer diameter of the rod-like shaped element is constant. Direct vicinity in this respect means that the support does not abut, rest or press upon a (locally) reduced inner diameter portion of the pipe-like shaped element (or outer diameter of the rod-like shaped element.

In embodiments, the shaped element has a constant, i.e. essentially invariable, inner/outer diameter as such a pipe-like shaped element is relatively easy and cheap to manufacture.

Hence, the process may for instance (also) comprise selecting the shaped element from a set of one or more shaped elements having a predetermined length, and reducing the length to a desired length preceding the arranging stage. Hence, in embodiments, the shaped element is selected from the group consisting of a pipe-like shaped element having an inner diameter and an outer diameter and a rod-like shaped element having a rod outer diameter, and especially at least locally the inner diameter and/or outer diameter is essentially invariable. Especially, the support may be arranged in and/or around the shaped element where at least locally the inner diameter and/or outer diameter are essentially invariable. Hence in embodiments, the arranging stage, especially (further) comprises arranging in and/or around the shaped element where at least locally said inner diameter and/or said outer diameter is essentially invariable at least part of a support of said at least two monolithic bodies, fastening the support to the at least part of the shaped element by pressing with a pressing element a fastening material against and/or into a shaped element wall of the shaped element; and coupling one or more optional functional elements other than the optics and the support.

The expression “the inner/outer diameter is essentially invariable” means to express that the inner/outer cross-section of the pipe-like element does not (locally) exhibit a sudden change in size in longitudinal direction; in other words the pipe-like shaped element is (locally) straight at its inner/outer wall, and hence the inner/outer wall itself for this reason cannot function as a pressing element and/or support assist.

Especially, the lighting device (also) comprises at least the light source.

Also the position of the functional element, (functionally) coupled to the support, in or around the shaped element can be customized, as in principle the support can be fastened anywhere to the shaped element. Hence, a large freedom to the (end) user is provided. Further, thermal coupling can be high, allowing the support to have the function of a heat spreader or heat sink and the shaped element to have the additional function of a heat sink, guiding the heat to surroundings of the lighting device (element). This effect is particularly obtained when the fixation of the support inside and/or around the shaped element is essentially fully circumferential, which is typically visible by the feature that the fastening material comprises a single, continuous and essentially fully circumferential indentation as then the (thermal) connection between shaped element and the support is maximized. This effect may also be obtained when the fastening material is pressed physical in contact with the shaped element wall via point protrusions, especially extending over at least 5%, such as over at least 25%, especially over at least 50%, of the circumference of said wall. Hence, in embodiments part of the fastening material is in pressed physical contact with the shaped element wall of the shaped element and/or protruding into said shaped element wall via continuous or via line/point protrusions extending over at least half of the circumference of said wall

Furthermore, when the indentation is completely fully circumferential, an advantageous gastight connection between the shaped element and the support is obtainable. Thus, with two, mutually spaced supports fixed inside the pipe-like shaped element, a gastight chamber is obtainable, which enables the accommodation of oxidation sensitive elements (when manufacture is performed under an inert atmosphere).

The lighting device (element) comprises at least two monolithic bodies providing the support and optics wherein at least one of the monolithic bodies is in contact with another of the monolithic bodies and in assembled position the optics is formed by the at least two monolithic bodies. If at least part of the support and at least part of the optics are configured as a (monolithic) single body, especially comprising the same material, heat transport between said part of the support and said part of the optics may be facilitated, and also the optics may function as a heat sink. Especially, an extra path for heat transport may be created by providing the support and optics by at least two monolithic bodies (especially comprising a thermally conductive material). This again may provide enlarged freedom to the (end) user, e.g. allowing to selecting housings having a shorter length, or changes in the material of the housing.

The lighting device element may have the feature that the at least two monolithic bodies both have a form-factor such that in assembled a form-fitting cavity is formed for accommodating and fixing at least one functional element. This means that the form factor is such that a functional element accommodated in once joined at least two monolithic bodies, it can only be released from the form-fitting cavity upon disassembling the joined at least two monolithic bodies. The technical feature of the form-factor renders the lighting device element to have the advantage that mounting of functional elements, for example a chip-on-board (COB) light source, can be done in a relatively quick and simple manner without the need of using glue, screws or other fixation means. Each monolithic body may have the feature that it is identical in shape to at least one of the other monolithic bodies. This has the advantage that number of different parts for assembling the lighting device element can be reduced.

Yet further, one or more functional elements and the support can be (functionally) coupled and then introduced and fastened to the shaped element, circumventing the more elaborate process of introducing first a support in/around the shaped element and subsequently introducing and (functionally) coupling the functional element, such as a light source and/or its electronics, to the support. Especially, for the at least two monolithic bodies comprising the support and the optics, the optics are (directly) coupled to the support. Especially, in such embodiments, the lighting device comprises at least said optics as functional element. The lighting device may comprise (other) functional elements. Especially the functional elements are (also) coupled to the support. The lighting device element may also comprise one or more further functional elements that are not coupled to the support. For instance, the lighting device element (or lighting device) may comprise further optics (in addition to the optics associated with the support), which are not (functionally or physically) coupled to the support. Of course, further functional elements may—however—in embodiments also be (functionally or physically) coupled to the support.

The lighting device element may comprise more than two monolithic bodies, such as three, or four monolithic bodies (which especially altogether provide the support and the optics). In other embodiments, the lighting device element comprises five to ten, or even more monolithic bodies (which especially altogether provide the support and the optics).

In embodiments comprising at least two monolithic bodies (providing the support and the optics), a functional element may be associated, especially coupled, to a respective part of a support (at one monolithic body) and the bodies may be (physically) connected before fastening the support to the shaped element. A functional element may also be coupled to the support after fastening the support to the shaped body. Hence, in embodiments, the lighting device element further comprises one or more connecting elements, wherein the one or more connecting elements are arranged for (especially) physically connecting the monolithic bodies (to each other). The connecting element may in embodiments comprise a slotted spring pin. In further embodiments, the connecting element may comprise a dovetail. In yet further embodiments another connecting element, such as sliding connection elements may be present. Hence, in embodiments, the lighting device element comprises at least two monolithic bodies, wherein the lighting device element further comprises a connecting element, wherein the connecting element physically connect the monolithic bodies, and wherein at least one of the monolithic bodies is in contact with another of the monolithic bodies . The term “connecting element” may also refer to a plurality of (different) connecting elements.

Especially, a part of a first monolithic body may be configured to overlap a part of a further (adjacent) monolithic body, especially to physically connect the monolithic bodies. Especially at least one of the monolithic bodies is in contact with another (adjacent) monolithic body.

Hence in further embodiments, wherein the lighting device element comprises at least two monolithic bodies, the process comprises associating the one or more functional elements other than the optics with at least one of said monolithic bodies, and physically coupling the at least two monolithic bodies.

Hence, the invention provides an optimized assembly process, since the invention allows the assembly of e.g. a LED module and or driver components to a (flat) support, a single support or a support provided by at least two monolithic bodies, before mounting the support into the narrow pipe-like element.

The process(es) described herein especially do(es) not require very specific tooling. Especially, only a simple tooling is required to mechanically (and thermally) fix the support (such as a heat-spreader support) to the shaped element. With a single tool, many different lengths of lighting device(s) (elements), such as a spot light, can be made. For another diameter again a simple tool is required. Standard production processes require tools that are optimized for a very limited amount of design options. The invention, however, allows high diversity in lighting device(s) (elements) designs. The toolset for the fixating the support to the shaped element (especially with a heatsink functionality, see below), as described herein requires low investment costs. Time to market can be short, since no extensive tooling design, engineering and testing are required. The shaped element may comprise a simple straight rod, pipe or tube, especially a tube requiring no extra preparation (before assembling a lighting device element) for positioning or holding the support or support assist, such as recesses or ridges or other elements to grip or rest a support (within the pipe-like shaped element). In embodiments, (a surface of) the shaped element wall may be roughened before pressing the fasting material at the shaped element. Yet, in further embodiments, such tube may (further) comprise a ridge or recess to facilitate positioning before pressing. Hence, the production as well as the base material may be low cost compared to solutions known in the art. A support or support assist may be arranged at any location inside and/or around the shaped element.

The invention described herein may especially also provide a lighting device (element) comprising a heatsink (see below). A (die-casted) heatsink known in the art is an expensive part that often needs a second processing step after extrusion (milling and separate heat-spreader to be fixed in profile) (die casting heatsink milling of heat-spreader surface, removal of burs by milling, turning etc. and creation of thread in screw holes within narrow cavity). In embodiments, the invention provides a final heatsink or a combined support and optics body (that comprise multiple monolithic bodies) within a single low cost production step, leading to a low-cost part.

The production of heatsinks can normally be done at selected but a limited amount of suppliers. A pressing system comprising the pressing element as described herein for pressing the fastening material against or into the pipe-like element may be a standard low pressure press, giving a wide variety on production options and potentially may be integrated in the assembly process instead of the production process. This enables a large supply base. The process as described herein allows a late stage configuration and a final placement of the support on demand, allowing a reduced stock.

Especially, the invention provides a process to fix two parts, especially a shaped element and a support (for one or more functional elements, such as a light source, electronics for a light source, heats sink, and optics for a light source), especially a combined support and optics body (comprising the support and the optics), to provide a mechanical fixation between the support and the shaped element.

The shape of the shaped element, either pipe-like or rod-like, may be any shape that is used in the art for providing a lighting device, such as a spot. The shaped element may have a circular cross-section. The shape may comprise a circular, triangular or square cross-section. The shaped element may also comprise a rectangular, pentagonal, hexagonal, elliptical, or octagonal cross-section, or other cross-section. Hence, in embodiments, the shaped element has a cross-section selected from the group consisting of circular, elliptical, triangular, square, rectangular, pentagonal, hexagonal, and octagonal. The shaped element especially comprises a tube. The symmetries listed here may apply to the internal shape and/or the external shape of the pipe-like shaped element. The external shape may differ from the internal shape. For instance, a pipe-like shaped element may have a cross-section that is square for the external shape but is circular for the internal shape of the pipe-like shaped element: i.e. a tube like element with a square outer shape.

The shaped element is especially an elongated element, having a length that is larger than the width/height or the outer diameter. In other embodiments, however, the shaped element may have a length that is smaller or equal to a width/or outer diameter. Further, the dimensions of the cross-section may vary over the length of the pipe-liked shaped element, like a conical shape or a pyramid-like shape.

The at least two monolithic bodies may especially be provided by a process allowing shaping of three dimensional bodies. The at least two monolithic bodies may, e.g. be provided by casting, injection molding or forging. The at least two monolithic bodies may be provided by die casting, especially high density die casting (HDDC).The at least two monolithic bodies may in embodiments be provided by semi-solid metal casting, especially by thixomolding. Especially, thixomolding may provide relatively thin dimensions (such as a thickness) of a (provided) body (such as the monolithic body). Herein a thickness may especially relate to a smallest dimension of an object, such as the optics. A thickness (especially of a thixomolded product, especially of the optics (part of the monolithic body) provided by thixomolding) may for instance be selected to be equal to or less than 5 mm, such as equal to or less than 2.5 mm, especially equal to or less than 2 mm, even more especially equal to or less than 1 mm. Especially the thickness (of the optics) may be equal to or more than 0.05 mm, such equal to or more than 0.1 mm, such as equal to or more than 0.2 mm, especially equal to or more than 0.5 mm. In embodiments, the optics comprises a thickness selected in the range of 0.05-5 mm, especially selected in the range of 0.1-5 mm, or selected in the range of 0.05-2 mm, such as 0.1-2 mm.

Thixomolding may especially provide objects comprising a complex structure, especially having a low porosity. Thixomolding may especially allow to providing a flat surface and/or smooth surface finish. The at least two monolithic bodies may especially comprise a complex structure, such as (a part of) of flat support (see also below) and (a part of) the optics, comprising e.g. a parabolic shape or a conical shape. Especially, the at least two monolithic bodies comprise a thixomolded monolithic body. Thixomolding, or other 3D shaping processes, may especially comprise shaping a magnesium alloy and/or an aluminum alloy. Hence, in embodiments, the at least two monolithic bodies comprise a magnesium alloy. In further embodiments, the at least two monolithic bodies comprise an aluminum alloy. In further embodiments, the at least two monolithic bodies comprise a die casted monolithic body, especially a high density die casted monolithic body.

The functional element as indicated above can be any element that is used for its function in the lighting device. Especially, herein the functional element is selected from the group consisting of a light source, electronics for a light source, a heat sink, and optics (and optionally further optics) for a light source. Especially, herein the functional element relates to the one or more functional elements, especially connected to the support. Note that the at least two monolithic bodies (the combined support and optics) especially comprise the support and the optics. Hence, especially the one or more functional elements comprise optics. Hence especially, said optics is physically coupled with the support. The term “functional element” may especially also refer to a plurality of functional elements. One or more of those functional elements may functionally be coupled with the support. Alternatively or additionally, one or more of those functional elements may physically be coupled with the support, such as e.g. a PCB comprising a light source (with the PCB configured as support). It is further noted that the electronics for a light source and/or any further optics for a light source may not necessarily be coupled with the light source that may in embodiments be coupled with the support as described herein. Especially, functional elements not coupled to the lighting device elements may be referred to as further functional elements. Likewise terms like “further optics”, “a further light source”, etc. may relate to further functional elements, especially not (physically) coupled to the respective support.

The one or more functional elements may (also) comprise a molded interconnected device (MID). Especially a molded interconnected device may provide coupling of the light source and (further) electronics (for the light source light). In embodiments, three dimensional conductive tracks are provided in the body comprising MID. In further embodiments, three dimensional (conductive) tracks are provided at a body (i.e. a functional element), e.g. by 3D printing, to provide a functional coupling between a light source and (further) electronics for the light source.

The (further) functional element may be (further) electronics for another light source and the further optical element may be an optical element for another light source. However, especially when electronics and/or further optics are configured as functional element at least partly in/around the shaped element, these are also (functionally) coupled with the light source that is (functionally) coupled with a support (at least partly configured with the shaped element). Moreover, in embodiments comprising more than one functional element, at least one functional element is functionally coupled to the support. Especially, in embodiments wherein the support and the optics are provided by the at least two monolithic bodies, at least the optics is functionally coupled to the support. In other embodiments at least two functionally elements are coupled to the support. Yet, in embodiments there may be a plurality of supports. In embodiments one or more functional elements other than the optics are coupled to the support.

The (one or more) functional elements, especially, comprise (the) optics for a light source. The functional elements may (alternatively or additionally) comprise (further) optics for a light source. For instance, the functional elements may comprise one or more lenses, diffusers, distance rings, glare reduction elements, optic windows, louvres, etc. The optics and/or additional optics (or further optics) may also comprise a beam shape element, an optical filter and/or a reflector, such as a CPC (Compound Parabolic Concentrator). The optics and/or further optics may comprise any combination of two or more of the above given examples. The optics may further comprise a coating, especially a reflective coating. The optics may further comprise a polished surface, such as a chemically polished surface or a mechanically polished surface. In embodiments the optics further comprises at least one of a (chemically) polished surface a coating, and facets. Especially, the optics (especially provided by the at least two monolithic bodies) comprises a reflector, especially comprising a reflective surface comprising facets. Especially, such facets may reflect light source light (emitted by a light source) in predetermined direction. Such facets may especially advantageously be provided by thixomolding. Such facets may further be polished (comprise a polished surface). In embodiments, the optional further optics for the light source may be arranged outside the lighting device element. The optics provided by the at least two monolithic bodies may completely be arranged within a pipe-like shaped element. The optics, may also be arranged partly outside the pipe-like shaped element. Especially, in a tube-like shaped element, a part of the optics adjacent to the support is arranged inside the tube-like shape element.

In other embodiments, the optics for the light source may be arranged outside the lighting device element. In such embodiments, the lighting device element may not comprise optics for the light source. Of course, a lighting device comprising the lighting device element may include optics (for the light source, however external from the lighting device element.

The (one or more) functional elements may also generate thermal energy (see below). Especially, the (heat generating) functional element as indicated above comprises (thus) a light source, that generates heat when providing light.

The light source can be any light source, including a halogen lamp, a high pressure lamp, a metal-halide lamp, a sodium lamp, a LED lamp, etc. In embodiments, the light source especially comprises a solid state lighting device. In a specific embodiment, the light source comprises a solid state LED light source (such as a LED or laser diode). In a further embodiment, the light source comprises a COB (Chip on Board) LED. The term “light source” may also relate to a plurality of (different) light sources, such as 2-20 (solid state) LED light sources. However, the light source may also include much more LED light sources. Hence, the term LED may also refer to a plurality of LEDs.

The at least two (optional) functional elements may (alternatively or additionally) comprise electronics for a light source. Especially, the electronics may regulate the power to the light source. The electronics may comprise a control system for controlling the light source. The electronics may also be part of a control system controlling the light source. The electronics may also comprise an (internally or externally arranged) sensor to sense a characteristic of the light source or the surrounding of the light source, such as the temperature or the ambient light. The control system may also control a plurality of light sources, especially e.g. light sources providing different colors of light. The electronics may especially control the light source, such as the power and/or the color (temperature) of the light source. The electronics may comprise an LED driver. The electronics for a light source also may generate heat when in operation.

In other embodiments, the electronics for the light source may be arranged outside the lighting device element. In such embodiments, the lighting device element does not comprise electronics for the light source. Of course, a lighting device comprising the lighting device element may include electronics (for the light source), however external from the lighting device element.

A functional element may be embodied as a heat sink, which could be arranged inside and/or outside (i.e. around) the pipe-like shaped element or around the rod-like shaped element. The heat sink may comprise at least one of the features of through holes, for example shaped as open circles or as elongated slots, fins (e.g. curved, straight, tapering etc.), rods, pipes and embossing, i.e. a profiled pattern on the main surface of the heat sink, to increase the surface exposed to the air and thus to enhance the heat dissipation functionality. The heat sink may comprises other functionalities next to cooling, for example, the light source, for example a plurality of LEDs, and/or electronics for example a sensor, and/or optics, for example a reflector, may be mounted on the heat sink. Especially the optics may (also) comprise a heat sink (functionality). The optics may (also) be embodied as a heat sink.

The support may allow coupling with one or more of the functional elements. Herein, the term “coupling” may refer to functionally coupling. The term “coupling” may especially (also) refer to physically coupling. The terms “coupling” or “connecting” and similar terms my equally be used.

One or more of the functional elements may be arranged in or around the lighting device element coupled to the support. Especially, one or more of the functional elements may be arranged in the pipe-like shaped element by fastening the support into the at least part of the pipe-like shaped element.

In embodiments, at least part of the functional element may (already) be coupled to the support before arranging the support to the shape element. Hence, in embodiments the support comprises the light source (when arranging at least part of the support to the shaped element). In further embodiments, the support comprises the electronics (for a light source) (when arranging at least part of the support to the shaped element). In embodiments, the support comprises at least the optics (for a light source) (when arranging at least part of the support to the shaped element). Hence, in yet further embodiments the support further comprises at least part of the functional element (when arranging at least part of the support to the shaped element).

In yet further embodiments, the support comprises a metal core printed circuit board (PCB).

The support may be flat. The support may also comprise holes, such as holes to fasten screws or other fasteners, or through holes (see below). In embodiments, the support comprises screw bosses. In further embodiments, the support comprises a hinge, especially for connecting with another element. In yet further embodiments, the support comprises an opening, especially for allowing means for electric transport, such as an electric wire. The openings (further) may provide an air flow, especially through the pipe-like shapes element, especially. In embodiments, the support comprises openings especially for thermal purposes.

The support may especially comprise a maximum dimension in a first direction much smaller than maximum dimensions in second and third direction (with all directions selected perpendicular to each other). Especially, the height of the support may be smaller than the width and the length. For instance, the support may have the shape of a disk. The support may comprise a minimum thickness (or height) to allow pushing a part of the fastening material comprised by the support in radial direction towards the shaped element wall. Especially, the height of the support is selected to be equal or larger than 1 mm, such as equal or larger than 3 mm, such as in the range of 3-10 mm. In embodiments, the maximum thickness (or height) of the support is 4 cm, such as 2 cm, especially maximal 1 cm. Especially, the height (or thickness) of the support is at least 0.1 mm. Especially, a support comprising a height less <1 mm may be fastened using a support assist.

Herein the term “support” may also relate to a plurality of supports. Especially a plurality of supports may comprise supports comprising different materials. A plurality of supports may also comprise supports comprising different dimensions. Further, a plurality of supports may support different types of functional elements.

The size of the support and the shaped element may be adapted to each other. Before pressing, (at least part of) the support may be arranged inside and/or around the shaped element having a clearance between the support and the shaped element. Especially, the size of the minimum clearance between the support and the shaped element may be in the range of 0.1-5 mm, such as 0.2-2.5 mm, or even 0.5-1 mm. By pressing with the pressing element, the clearance will at least partly disappear (filled with fastening material). Especially having an initial small clearance requires less fastening material to be pushed towards or in the shaped element wall (and in the clearance).

The arranging stage may comprise fastening at least part of the support to the at least part of the shaped element by pressing with a pressing element the fastening material against or into the shaped element. The technology of pressing may be comparable to the pressing technology applied in pressing of a coin, especially comprising a center and a periphery. However, pressing as described herein especially fastens material to a shaped element by pushing part of the material in a radial direction towards the shaped element wall. Hence, by pressing the fastening material (comprised by the support and/or by the optional support assist, see below), especially part of the fastening material will be pushed (at least) towards the shaped element wall and be pressed against said wall or partly into said wall. In the former embodiment, a friction-type fastening or connection may be obtained. In the latter embodiment, the support or the support assist is fixated as part of the support or support assist protrudes into the wall and thereby substantially prevents translational or rotational movement of the support or support assist, respectively.

The tube is hollow over at least part of its length, allowing introduction of the support (and support assist, if applicable). Hence, the support can be accommodated within the pipe-like shaped element. The internal (hollow) shape may substantially have any shape (see also above). Hence, the tube with internal hollow shape is herein indicated as “pipe-like shaped element”.

The support especially comprises the optics. The dimensions of the optics may especially be selected to allow a pressure element to contact a peripheral of the support, especially while preventing the pressure element to (negatively) affect the optics. In embodiments, a characteristic dimension (e.g. a diameter) of the optics, especially in a plane parallel to a plane of the support, is smaller than a characteristic dimension (e.g. a diameter) of the support. In other embodiments, especially wherein a part of the optics is arranged outside the pipe-like shaped element, said characteristic dimension of the optics may be larger than said characteristic dimension of the support. Hence, a pressure element (of a pressing system) may be applied that only contacts the peripheral of the support. Using such pressure element may allowing pre-assembling of the support (heat-spreader), (optional) optics and optionally light source and/or electronics for the light source and successively arrange the pre-assembled support in and/or around the shaped element and fasten the (pre-assembled) support to the shaped element. In embodiments comprising more than one monolithic body, advantageously at least one (optional) functional element may be coupled to at maximum all but one monolithic bodies and successively the at maximum all but one monolithic bodies can be connected with the other respective monolithic body/bodies, especially before fastening the (preassembled) support of the (one or) more monolithic bodies to the shaped element. This may allow a well accessible and optimized (late stage configuration) production process. In yet a further aspect, the invention also provides such pressing system per se and/or such pressing element per se.

A wall of the shaped element may be harder than the fastening material. Especially, when the material of the wall of the shape element (“wall material”) is harder than the fastening material, the fastening material may be pressed against the wall. The wall material also may be in the range of the hardness of the fastening material. In embodiments, the hardness of the wall material is not substantially lower than the hardness of the fastening material. Especially, when the fastening material has a (much) higher hardness than the wall material, the fastening material may be pressed into the wall of the shaped element. Especially, a material of the wall is harder than the fastening material allowing the fastening material to deform, whereas the shaped element substantially does not deform. In yet other embodiments, the hardnesses are comparable (such as mutual hardness differences within 10%). Especially, a pressing element, pressure, and shaped element are selected to prevent pressing of fastening material through the shaped element, but only against or into the wall of the shaped element. To allow pushing the fastening material, the fastening material especially is deformable (tough and not brittle). Especially, the fastening material comprises deformable fastening material. To allow pressing the fastening material into the shaped element, the shaped element may in embodiments also comprise deformable material, such as a metal, metal alloy or a soft polymer. The fastening material is deformable under pressure, such as under a pressure of at least 10 MPa, such as at least 20 MPa, especially a pressure selected in the range of 20-500 MPa. Especially the fastening material may comprise a yield strength selected in the range of 10-500 MPa, such as 10-100 MPa. In other embodiments, however, the fastening material may comprise a yield strength selected in the range of 100-400 MPa, such as 100-200 MPa.

However, the shaped material may also comprise other material, especially when the fastening material is pressed against the shaped element. For instance, the shaped element may comprise a hard polymer, glass, quartz glass, or a noble metal. Hence, in embodiments the shaped element wall comprises a wall material comprising one or more of glass and quartz.

In embodiments, the process, especially the arranging stage, further comprises roughening at least part of a surface of the shaped element wall (of the shaped element), especially before pressing with a pressing element the fastening material against and/or into the shaped element wall. In embodiments roughening comprises knurling.

In embodiments, the arranging stage further comprises moving, such as sliding and/or rotating, the support and/or the optional support assist over a certain distance before, during and/or after pressing the fastening material. Especially, such moving may improve the (physical) contact between the fastening material and the shaped element wall, thereby especially minimizing possible heat resistance between the fastening material and the shaped element wall.

Especially, coupling the functional element and the support comprises mechanical fixation between the support and the shaped element. In embodiments, (at least part of) the support is fastened (directly) at (against or into) the shaped element. Especially, in such embodiments the support comprises the fastening material. Especially the support may consist of the fastening material. Especially, the support material may be the fastening material.

As indicated above, the coupling of the functional element and the support may be done before configuring the support to the shaped element or after configuring the support to the shaped element (and optionally even during configuring the support to the shaped element). With the invention, a prefabrication of the support and functional element is possible, which facilitates manufacture of the lighting device element and lighting device. In embodiments, (at least of the) the at least two monolithic bodies are coupled to one or more functional elements and connected mutually (as described above) to provide the prefabrication of the support and functional element(s).

Herein, the term “the support material” may also refer to the material comprised by the support. Herein, also the term “support assist material” relates to the material comprised by the support assist, and the “wall material” relates to the material comprised by the shaped element wall.

As indicated above, the support may be fixated directly (without support assist), or indirectly via the support assist. This latter option will further (also) elucidated below. In specific embodiments also both fixations may be applied.

Hence, in further embodiments (at least part of) the support is fastened indirectly at (against or into) the shaped element by fastening (at least part of) the support assist at the shaped element. Especially, in such embodiments the support assist (also) comprises the fastening material. In such embodiments the support assist may consist (part of) the fasting material. Especially, in such embodiment the support material (i.e. the material of the support) may not necessarily comprise fastening material, and especially the support assist material is the fastening material. Fastening (at least part of) the support assist at the shaped element may be provided by pressing with the pressing element.

Especially, the support assist comprises a receptor opening (configured) to receive (at least part of) the support. The term “a receptor opening” may also relate to a plurality of (different) receptor openings. In embodiments, the support assist may comprise two support assist parts (comprising fastening material). Especially in such embodiments, the process may comprise arranging the support between at least part of the two support assist parts in and/or around the shaped element, especially before pressing the fastening material against or into the shaped element. Such embodiments may also comprise a (further) receptor opening (and/) or recess in one or in both support assist parts.

The support or support assist if applicable may substantially have any shape. However, especially at least part of the support or support assist if applicable has a shape substantially identical to the internal and/or external shape of the shaped element. For instance, the support or support assist if applicable may be square for a pipe-like shaped element having a square (internal) cross section. Hence, the support, (and/)or where applicable the support assist may (also) have a cross-section selected from the group consisting of circular, elliptical, triangular, square, rectangular, pentagonal, hexagonal, and octagonal, respectively.

However, for such shaped element having a square (internal/external) cross section also a cross-shaped support or support assist if applicable may be applied.

Further, by way of example the support or support assist if applicable may be circular for a shaped element having a circular (internal/external) cross section. However, for such cross-section also a spoked support or support assist if applicable may be applied.

Hence, substantially any shape with support material that can be deformed to provide the fixation to and/or into the wall may be applied.

In embodiments, the support may comprise a metal core PCB, which may be fastened to the shaped element by arranging the PCB in the receptor opening of a support assist and pressing the fastening material (of the support assist) in a radial direction towards the wall of the shaped element. Especially, a metal core PCB comprises a metal core that may facilitate heat transport towards the wall, thus simultaneously function as a heat sink.

Especially, the support assist may also consist of electrically non-conductive material, such as a polymer, especially to insulate the support electrically from the shaped element. Such an electrically insulating material may be beneficial when the support already may provide sufficient heat removal of the heat generated by the functional element(s), especially wherein electrical insulation to the surroundings of the lighting device elements is required. For instance, the support may comprise a heatsink or heat spreader.

In embodiments the term “pressing” refers to applying local pressure on the peripheral of the support or the support assist and pushing fastening material outwards. When applying an asymmetric shape of the geometry of the pressing element, one can manipulate in what direction the material is pushed. For instance, a larger slope of the area contacting the fastening material may push more fastening material in the intended direction. Pressure can be applied in a point, partial trajectory or a line fully around the periphery of the fastening material.

In embodiments, the shaped element comprises a rest to receive the support (or support assist). Especially, (a part of) the support (or support assist) may be fastened at the rest by pressing with the pressing element the fastening material against and/or into the shaped element wall, especially at the location of the rest.

Especially, the pressing element may comprise one or more shapes configured to press material in an outward direction relative to a central axis of the pressing element when the support is mounted inside the shaped element, the pressing element may comprise one or more shapes configured to press material in an inward direction relative to a central axis of the pressing element when the support is mounted on the outside, i.e. fully or partially around, of the shaped element. The pressing element may in embodiments comprise multiple shapes configured to press the (complete) peripheral region of the fastening material evenly in one pressing action. The central axis may in such an embodiment be a longitudinal axis of the pressing element through the center of the pressing element. In other embodiments, especially wherein the shape element comprises a circular cross section, the pressing element may comprise only one shape and the pressing element may rotate around a (rotational) axis to press the peripheral of the support around substantially the complete peripheral evenly in a sequence of pressing actions. In such an embodiment, the central axis may be defined as the (rotational) axis rotated around (although the pressing element will also have an axis of its own). Hence, the central axis is a functional axis as will be understood by a skilled person. In other embodiments, the shape(s) configured to press material in an outward/inward direction (whichever is applicable) relative to a central axis may have a cylindrical shape. With the pressing element, support material may be pressed/moved in a radial direction (in)to the shaped element wall. Especially, the shape of the pressing element is configured not to negatively affect, such as damage, the optics provided by the at least two monolithic bodies (during pressing). Hence especially, the shape may comprise an opening allowing to accommodate (and/or shield) the optics during pressing the fastening material.

Pressing the fastening material (towards the shaped element wall) may especially comprise pressing the fastening material locally (such as at the periphery of the support or the support assist) and pushing locally the fastening material towards or into the shaped element wall. Therefore, an imprint (in the fastening material) may be provided by the pressing element. Hence, in embodiments, the lighting device element according to the invention comprises fastening material comprising an indentation adjacent to the shaped element wall of the shaped element. In embodiments, the indentation is at maximum 1 mm deep. In another embodiment, the indentation is in the range of 0.5-3 mm, such as in the range of 0.5-2 mm, especially 0.5-1.5 mm deep. Further, the fastening material is in physical contact with said shaped element wall and/or is protruding into said shaped element wall. The term “indentation” may also refer to a plurality of indentations.

In embodiments, the fastening material is protruded in the shaped element wall over a protrusion distance. Especially, the protrusion distance is in the range of 0.05-3 mm, such as 0.05-05 mm, especially the protrusion distance in in the range of 0.05-0.15 mm. In embodiments the protrusion distance is less than 0.05 mm. As indicated above, the protrusion distance is especially chosen to be smaller than the thickness of the wall of the shaped element.

Hence, especially support material at an edge of the support or support assist, adjacent to the wall of the shaped element is pressed/moved in a radial direction (in)to the shaped element wall. Hence, in embodiments the support comprises a central point and a perimeter with a maximum length (L1) between the central point and the perimeter and/or wherein the support assist comprises a central point and a perimeter with a maximum length (L2) between the central point and the perimeter, and the process comprises pressing with said pressing element fastening material configured at a distance from the central point of at least 90% of the maximum length (L1,L2). Especially during pressing the central point of the support may be on the central axis of the pressing element.

It may further be desirable that heat from the light source and/or from the electronics are efficiently dissipated. Hence, when the light source (and/or the electronics) is coupled with the support, it may be desirable that the support (and the optics) is (are) thermally conductive. Further, it may be desirable that the heat may be further dissipated from the support, such as to the wall of the shaped element.

The mechanical fixation may provide a thermal path through these fixated parts (from the functional element, especially the light source, to the element, and especially further to the surroundings), especially if the parts comprise thermally conductive material. Hence, in embodiments the shaped element wall comprises a wall material that is thermally conductive, the fastening material (also) comprises a thermally conductive fastening material, and the support comprises a fastening material that is (also) thermally conductive, especially in embodiments wherein the functional element comprises said light source, and wherein said light source is configured in thermal contact with said fastening material. Hence, a thermal path is provided from said light source via the support to the shaped element wall and especially also to the optics. In embodiments wherein also a support assist is applied, the thermal path may be provided from the support via the support assist to the shaped element wall.

Especially, the invention provides a (process for the production of a) lighting device (element) comprising a heat sink, and especially optics. Especially, the support (and optionally the support assist) may function as a heat-spreader. Especially, a heat-spreader comprises the support. Especially the shaped element may function as a heat sink. Especially also the optics may function as a heat sink.

In embodiments, the wall material, the support material, and the optional support assist material allow heat transfer. Especially the support material and the material of the optics (“optics material”) comprise the same material, especially the monolithic body material. Especially a material of the support and a material of optics are the same material. The wall material, the fastening material, the support material, the optics material, and the optional support assist material especially (each independently) comprise a material selected from the group consisting of aluminum, magnesium, copper, and silver, especially aluminum and/or copper. The support and the optional support assist may comprise aluminum and/or an alloy thereof. Suitable materials may e.g. one or more of aluminum alloys 1051, 6061, 6063, copper, copper-tungsten, magnesium, silver and combinations of two or more of the afore mentioned. However, other high thermal conductive materials may also be applied. The shaped element may comprise the same material. Especially, one or more of the support material, the optics material, the support assist material, the fastening material, and the wall material comprises one or more of the afore-mentioned high thermal conductive materials or another high thermal conductive material. Herein, the term “thermally conductive” especially refers to a material having a thermal conductivity of at least 5 W/(m K), such as at least 10 W/(m K), especially at least 100 W/(m K). Examples of suitable materials include steel, aluminum, copper, AlN, BN, SiC, AL6061, etc. (see also above). The support material, optionally the support assist material, and (when present) the monolith body material may especially comprise the same material.

The at least two monolithic bodies comprise a monolithic body material. In embodiments, the support material, especially the monolithic body material, comprises aluminum. In further embodiments, the support material, especially the monolithic material, comprises magnesium. In yet further embodiments, support, especially the monolithic body material, comprises zinc and/or copper. Especially, the support material, especially the monolithic body material, comprises a metal. Herein a metal may relate to a pure metal. A metal may also relate to a plurality of (different) metals, especially a metal may relate to a (metal) alloy. Especially, the monolithic body material may relate to an aluminum alloy or a magnesium alloy. Such alloy may further comprise silica.

Especially, the at least two monolithic bodies comprises a magnesium alloy. Especially, the at least two monolithic bodies comprises an aluminum alloy suitable for die casting. Such alloys are known and for instance comprise ADC1, ADC3, ADC5, ADC6, ADC10, ADC10Z, ADC12, ADC12Z, ADC14, AC-46200, AC-47100, AC-51200, AC 71000, Zamak (zinc/aluminum alloy), and the like.

Especially, the at least two monolithic bodies comprise material, especially an alloy that may be thixomolded. Hence, especially, the monolithic body material comprises a material that may be thixomolded. In embodiments, the at least two monolithic bodies comprises an alloy selected from the group consisting of ADC12, AZ91, AZ91D and AM60B. In embodiments, the monolithic material comprises thermally conductive material. In further embodiments, the monolithic material comprises a non thermally conductive material.

The shaped element, the support and the optional support assist may essentially consist of one or more high thermally conductive materials. For instance, the shaped element, the support, and the optional support assist, may consist of aluminum (alloy).

However, the shaped element may also comprise another (thermally substantially non-conductive) material, such as glass or quartz glass. The shaped element wall may essentially consist of a thermally non-conductive material. Such an embodiment may e.g. be suitable for lighting device elements wherein the generated heat may adequately be transported by convection (see below).

Especially, the wall material and the support material and/or the support assist material may be selected such that a temperature change may affect an expansion of the wall material in a same extend as an expansion of the support and/or the support assist. Especially a ratio of a coefficient of thermal expansion of the wall material to a coefficient of thermal expansion of the support material (and/or the support assist) may be selected in the range of 0.5-2, especially 0.7-1.4, especially 0.85-1.2, even more especially 0.9-1.1. The thermal expansion ratio of the support may especially be equal to or larger than the expansion ratio of the wall material. Especially, the wall material comprises a coefficient of thermal expansion in the range of 25±5 μm/m·K. Especially, the support material comprises a coefficient of thermal expansion in the range of 25±5 μm/m·K. Further, especially, the support assist material comprises a coefficient of thermal expansion in the range of 25±5 μm/m·K. Especially, (also) the at least two monolithic bodies comprises a coefficient of thermal expansion in the range of 25±5 μm/m·K. Especially, the support material and/or the support assist material, and/or the wall material, and/or the material of the at least two monolithic bodies, are selected to comprise a thermal expansion coefficient in the range of 20-30 μm/m·K, such as 20-28 μm/m·K, especially 22-28 μm/m·K., even more especially 21-26 μm/m·K. such as 24-26 μm/m·K.

The shaped element wall may also consist of one or more thermally non-conductive materials and one or more thermally conductive materials. For instance, the shaped element wall may comprise a part of the wall comprising thermally conductive material, spaced apart by a part of the wall comprising thermally non-conductive material.

In embodiments, the fastening material comprises a (thermally conductive) material selected from the group consisting of aluminum, copper, steel, stainless steel, brass, gold, and silver. Especially, the fastening material essentially consists of the thermally conductive material.

With the described heat sink, especially with the combined support and optics, the functional element in a device, such as a light source, may better be cooled, leading to a more efficient operating of the device (such as the light source). Heat sinks are known in the art. A heat sink can be defined as a passive heat exchanger that cools a device by dissipating heat into the surrounding medium. A heat sink is especially designed to maximize heat transport to the cooling medium surrounding it, such as the air. The heat sink and the functional element may be in physical contact with each other. However, alternatively or additionally, there may be a thermally conductive medium in between, such as a thermal adhesive or thermal grease, or another thermally conductive material (as described herein). Hence, the heat sink is configured to dissipate thermal energy from the functional element, especially the light source (when in operation).

Especially, the heat sink is configured to allow during operation of the lighting device an air flow to flow. In embodiments, the support comprises one or more of through holes, pipes to allow air to flow, and/or rods, fins, embossing to increase the heat dissipating surface of the heat sink. In a further embodiment, a plurality of supports comprising through holes is provided (and fastened) to the shaped element and a pattern of through holes may be provided to the heat-sink function. The person skilled in the art will know how to arrange the through holes in a heat sink to provide best thermal energy dissipation properties during normal (or intended) use of the (lighting) device. Especially the optics (provided by the at least two monolithic bodies) may be configured not to contact the shaped element wall, especially not to obstruct possible convection between the shaped element wall and the optics, especially to facilitate heat transfer from the optics and from the shaped element wall to the surroundings. Especially, an (open) space between the optics and the (pipe-like) shaped element wall may comprise a decorative element, especially allowing an airflow to pass. Alternatively or additionally, the optics, especially optics contacting the shaped element wall may comprise openings to allow an airflow through the optics. Such openings may also be configured to allow a pressing tool to pass through the optics (to the support). Optionally, the device may further include a fan to generate such flow. Especially, heat transport in the lighting device (element), especially in the heat sink, may comprise convection and conduction, especially conduction. For instance, the support may include at least one of the cooling features of through holes, pipes, rods, embossing, and heat fins.

Hence, in embodiments, the lighting device and/or the lighting device element described herein comprises a support (further) comprising cooling features and especially optics for a light source.

In yet a further aspect, the invention also provides such lighting device element per se, i.e. a lighting device element comprising (i) at least one shaped element selected from the group consisting of a pipe-like shaped element and a rod-like shaped element, (ii) one or more functional elements selected from the group consisting of a light source, electronics for a light source, a heat sink and optics for a light source, and (iii) a support for the one or more functional elements, especially wherein the lighting device element comprises at least said optics as functional element, and especially wherein the lighting device element comprises at least two monolithic bodies, each monolithic body comprising at least part of the support and at least part of the optics, (and especially) with said at least two monolithic bodies providing thereby said support and said optics, wherein (a1) at least part of the support and (a2) at least part of the one or more functional elements are accommodated within and/or around the shaped element; wherein the support and the one or more functional elements are coupled; wherein (b1) the support comprises at least part of a fastening material and/or (b2) a support assist, at least partly configured within and/or around the shaped element, comprises at least part of the fastening material and the support assist comprises a receptor opening hosting at least part of the support; wherein adjacent to a shaped element wall of the shaped element the fastening material comprises (c1) an indentation and (c2) (part of) the fastening material is in (pressed) physical contact with said shaped element wall and/or protruding into said shaped element wall.

Especially, the functional element(s) are coupled to allow the lighting device element to provide a light source light and optionally to control the light source light. The lighting device element may especially be obtainable with the process for the production of the lighting device element as described herein. Especially, the support is (especially) locally (via the fastening material), fixed to the shaped element.

Such lighting device element may be used for providing a lighting device as described herein. Such lighting device may comprise one or more lighting device elements.

Hence, in a further aspect, the invention provides a process for the production of a lighting device, the lighting device comprising a lighting device element comprising a shaped element and a light source, the lighting device further comprising electronics for the light source and optionally optics for the light source, wherein the process comprises assembling the shaped element, the light source, the electronics, the optional optics and optionally one or more other elements, into the lighting device while assembling the lighting device element according to the process (for the production of a lighting device element) as described herein.

In an embodiment the process for the production of a lighting device, the lighting device comprises a lighting device element comprising at least one shaped element selected from the group consisting of a pipe-like shaped element, a rod-like shaped element, and optionally a light source, the lighting device further comprising electronics for the light source, a support (for one or more functional elements), and (optionally) optics for the light source wherein the process comprises assembling the shaped element, the electronics, the support, the (optional) optics, and optionally the light source and one or more other elements, especially a heat sink, to the lighting device while assembling the lighting device element according to the process for the production of a lighting element as described herein.

Especially, the lighting device comprises the light source. Especially, the lighting device comprises the (optional) optics. In embodiments, the lighting device comprises at least two monolithic bodies providing the support and optics for the light source.

As can be derived from the above, such lighting device allows a high design freedom. The lighting device can be custom made and may be tailed to specific areas or rooms, taking into account dimensions of the areas or rooms, respectively, and other sources of lighting for such areas or in such rooms, respectively.

In yet another aspect, the invention also provides such lighting device per se, (e.g. obtainable with the herein described process for the production of such device) i.e. a lighting device comprising a lighting device element described herein, the lighting device comprising the shaped element and optionally the light source, the lighting device further comprises electronics for the light source and optics for the light source, and optionally one or more other elements, wherein the light source, the electronics for the light source, the optics for the light source, and the optional one or more other elements are (functionally) coupled to the lighting device. The lighting device may especially be obtainable with the process for the production of the lighting device as described herein.

Hence, the lighting device (element) produced according to the invention may at least comprise optics and electronics for the light source. Additionally or alternatively, the lighting device (element) may comprise the light source and one or more other elements. Especially, the lighting device (produced) according to the invention comprises at least two monolithic bodies providing the optics and the support as described herein.

In embodiments, the lighting device comprises a spot (light) comprising a light source, optics for the light source, such as a glare reduction system, and a hinge to fasten the lighting device (to e.g. a ceiling). In another embodiment, the lighting device comprises a plurality of light sources, and a control system (comprising the electronics for the light source), etc. configured in one lighting device. In yet a further embodiment, the lighting device comprises a light source and optics for the light source, especially a reflector comprising a reflective surface, especially comprising facets.

As mentioned above, the invention also provides a lighting device element and a lighting device per se, especially the lighting device and the lighting device element assembled according to the processes described herein. Hence, embodiments described for the processes also relate to embodiments of the lighting device and the lighting device element. Especially, embodiments of the lighting device and the lighting device element may also be assembled using the processes described herein.

The invention also provides (in embodiments) a lighting device element comprising (i) a pipe-like shaped element, (ii) one or more functional elements selected from the group consisting of a light source, electronics for a light source, and optics for a light source, and (iii) a support for the one or more functional elements, wherein (a1) at least part of the support and (a2) at least part of the one or more functional elements are accommodated within the pipe-like shaped element; wherein the support and the one or more functional elements are coupled; wherein (b1) the support comprises at least part of a fastening material and/or a support assist, at least partly configured within the pipe-like shaped element, comprises at least part of the fastening material and the support assist comprises a receptor opening hosting at least part of the support; wherein adjacent to a pipe-like shaped element wall of the pipe-like shaped element the fastening material comprises (c1) an indentation and (c2) part of the fastening material is in physical contact with said pipe-like shaped element wall and/or protruding into said pipe-like shaped element wall.

The invention also provides a process for the production of such lighting device element, wherein the lighting device element comprising a pipe-like shaped element and (ii) one or more functional elements selected from the group consisting of a light source, electronics for a light source, and optics for a light source, the process comprising an arranging stage, the arranging stage comprising: arranging (a1) at least part of a support for the one or more functional elements and (a2) at least part of the one or more functional elements in the pipe-like shaped element, fastening the support into the at least part of the pipe-like shaped element by pressing with a pressing element a fastening material against and/or into a pipe-like shaped element wall of the pipe-like shaped element; and coupling the one or more functional elements and the support; wherein (b1) the support comprises at least part of the fastening material and/or (b2) a support assist, at least partly configured within the pipe-like shaped element, comprises at least part of the fastening material and the support assist comprises a receptor opening configured to receive at least part of the support.

Especially, the invention provides (in embodiments) a lighting device element comprising (i) at least one shaped element selected from the group consisting of a pipe-like shaped element having an inner diameter and an outer diameter, and a rod-like shaped element having a rod outer diameter, (ii) one or more functional elements selected from the group consisting of a light source, electronics for a light source, a heat sink and optics for a light source, and (iii) a support for the one or more functional elements, wherein (a1) at least part of the support and (a2) at least part of the one or more functional elements are accommodated within and/or around the shaped element; wherein the support and the one or more functional elements are coupled; wherein (b1) the support comprises at least part of a (deformable) fastening material and/or (b2) a support assist, at least partly configured within and/or around the shaped element, comprises at least part of the (deformable) fastening material and the support assist comprises a receptor opening hosting at least part of the support; wherein adjacent to a shaped element wall of the shaped element the fastening material comprises (c1) an indentation and (c2) part of the fastening material is in (pressed) physical contact with said shaped element wall and/or protruding into said shaped element wall.

The invention also provides a process for the production of such lighting device element, wherein the lighting device element comprises (i) at least one shaped element selected from the group consisting of a pipe-like shaped element having an inner diameter and an outer diameter and/or a rod-like shaped element having a rod outer diameter and (ii) one or more functional elements selected from the group consisting of a light source, electronics for a light source, a heat sink, and optics for a light source, the process comprising an arranging stage, the arranging stage comprising: arranging in and/or around the shaped element, especially where at least locally said inner diameter and/or said outer diameter is essentially invariable, (a1) at least part of a support for the one or more functional elements and (a2) at least part of the one or more functional elements, fastening the support to the at least part of the shaped element by pressing with a pressing element a (deformable) fastening material against and/or into a shaped element wall of the shaped element; and coupling the one or more functional elements and the support; wherein (b1) the support comprises at least part of the fastening material and/or (b2) a support assist, at least partly configured within or around the shaped element, comprises at least part of the fastening material and the support assist comprises a receptor opening configured to receive at least part of the support.

Especially, the fastening material is in pressed physical contact with the shaped element wall and/or protruding into the pipe-like shaped element wall via continuous or via line/point protrusions extending over at least half of the circumference of the (shaped element) wall, via which the support is locally fixed to the shaped element, especially where at least locally said inner diameter and/or said outer diameter is essentially invariable

Especially, the lighting device element comprises at least said optics as functional element. Especially, the lighting device element comprises at least two monolithic bodies, each monolithic body comprising at least part of the support and at least part of the optics, with said at least two monolithic bodies providing thereby said support and said optics.

In a specific embodiment, the invention provides the lighting device element, wherein the shaped element wall comprises a thermally conductive wall material, the fastening material comprises a thermally conductive (fastening) material, the support comprises a thermally conductive (support) material and the optics comprises a thermally conductive optics material. Especially, the functional element comprises the light source and the light source is configured in thermal contact with said support material and with said optics material. Especially, the lighting device comprises at least the light source. Especially, the lighting device element at least comprises the light source (as functional element).

The lighting device element of the invention comprises a shaped element. In embodiments, the pipe-like shaped element may have an inner diameter and an outer diameter. In further embodiments, the rod-like shaped element may have a rod outer diameter. Hence, in embodiments of the process for the production of a lighting device element, arranging in and/or around the shaped element comprises arranging in and/or around the shaped element where at least locally said inner diameter and/or outer diameter is essentially invariable.

In further embodiments of the lighting device element, the fastening material is in pressed physical contact with the shaped element wall and/or protruding into the pipe-like shaped element wall via continuous or via line/point protrusions extending over at least half of the circumference of the (shaped element) wall, via which the support is locally fixed to the shaped element where at least locally said inner diameter and/or said outer diameter is essentially invariable.

In a specific embodiment of the process for the production of the lighting element, the lighting device element comprises (i) at least one shaped element selected from the group consisting of a pipe-like shaped element having an inner diameter and an outer diameter and a rod-like shaped element having a rod outer diameter and (ii) one or more functional elements selected from the group consisting of a light source, electronics for a light source, (a) heat sink, and (further) optics for a light source, and (iii) a support for the one or more functional elements, wherein the lighting device comprises at least said optics as functional element, wherein the lighting device element comprises at least two monolithic bodies, each monolithic body comprising at least part of the support and at least part of the optics, with said at least two monolithic bodies providing thereby said support and said optics, the process comprising an arranging stage, the arranging stage comprising: arranging in and/or around the shaped element where at least locally said inner diameter and/or said outer diameter is essentially invariable at least part of the support of said at least two monolithic bodies, fastening the support to the at least part of the shaped element by pressing with a pressing element a deformable fastening material against and/or into a shaped element wall of the shaped element; and coupling one or more optional functional elements other than the optics and the support; wherein the support comprises at least part of the deformable fastening material and/or a support assist, at least partly configured within or around the shaped element, comprises at least part of the deformable fastening material and the support assist comprises a receptor opening configured to receive at least part of the support; and especially wherein the lighting device element at least comprises said light source.

In a specific embodiment, the lighting device element comprises i) at least one shaped element selected from the group consisting of a pipe-like shaped element having an inner diameter and an outer diameter and a rod-like shaped element having a rod outer diameter, (ii) one or more functional elements selected from the group consisting of a light source, electronics for a light source, (a) heat sink and optics for a light source, and (iii) a support for the one or more functional elements, wherein the lighting device element comprises at least said optics as functional element, wherein the lighting device element comprises at least two monolithic bodies, each monolithic body comprising at least part of the support and at least part of the optics, with said at least two monolithic bodies providing thereby said support and said optics, wherein (a1) at least part of the support and (a2) at least part of one or more functional elements are accommodated within and/or around the shaped element; wherein the support and the one or more functional elements are coupled; wherein (b1) the support comprises at least part of a (deformable) fastening material and/or (b2) a support assist, at least partly configured within and/or around the shaped element, comprises at least part of the (deformable) fastening material and the support assist comprises a receptor opening hosting at least part of the support; wherein adjacent to a shaped element wall of the shaped element the fastening material comprises (c1) an indentation and (c2) part of the fastening material is in (pressed) physical contact with said shaped element wall and/or protruding into said shaped element wall, especially via continuous or via line/point protrusions extending over at least half of the circumference of said wall, especially via which the support is locally fixed to the shaped element where at least locally said inner diameter and/or outer diameter is essentially invariable; and especially wherein the lighting device element at least comprises said light source.

Amongst others, the invention may be applied in LED lighting solutions, such as in lighting applications with LEDs.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-1B schematically depict some aspects and embodiments of the lighting device element;

FIG. 2 schematically depicts some further aspects and embodiments of the lighting device element;

FIGS. 3A-3B schematically depict some aspects of the process described herein;

FIG. 4 schematically depicts some aspects of the light source device element;

FIG. 5 schematically depicts some aspects of an embodiment of the process for the production of a lighting device element;

FIG. 6 schematically depicts some aspects and embodiments of the invention; and

FIG. 7 schematically depicts an embodiment of the lighting device;

FIG. 8 shows a picture photograph of an embodiment showing the support protruded in the pipe-like shaped element;

FIG. 9 schematically depicts some further aspects of an embodiment of the lighting device element;

FIG. 10 schematically depicts some further aspects of an embodiment of the lighting device element;

FIGS. 11A-D schematically depict some further aspects of further embodiments of the lighting device element;

FIG. 12 schematically depicts some further aspects of an embodiment of the lighting device element, and

FIG. 13A-B schematically depicts yet some further aspects of an embodiment of the lighting device element.

The schematic drawings are not necessarily on scale.

### DETAILED DESCRIPTION OF THE EMBODIMENTS

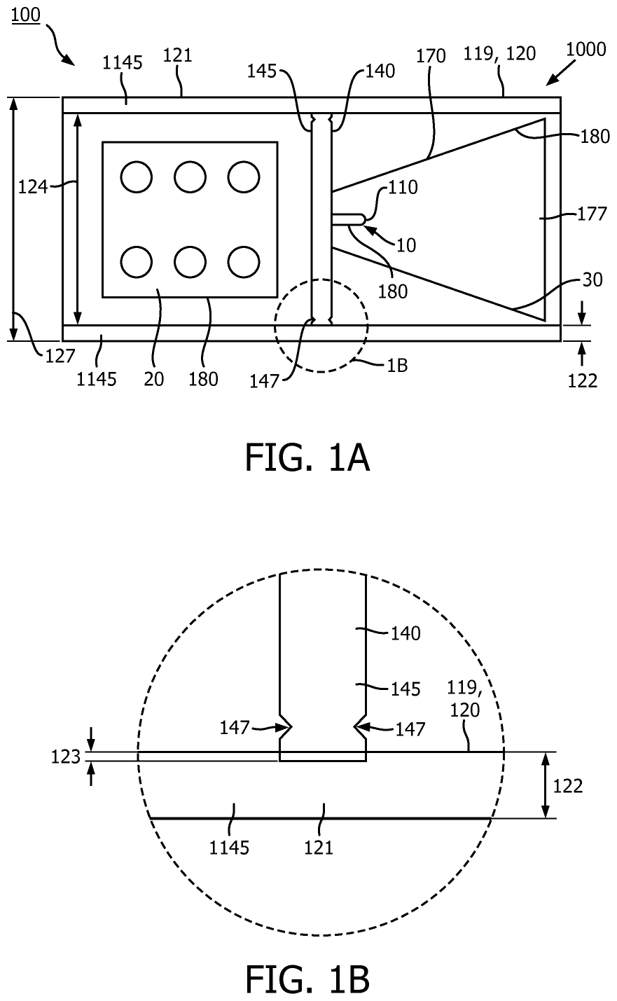

FIG. 1A schematically depicts some aspects of an embodiment of (the process for production of) the lighting device element 100 and the lighting device 1000. The lighting device element 100 schematically depicted in FIG. 1A, comprises a pipe-like shaped element 120,119, a support 140 and three functional elements 180, i.e., a light source 10, electronics 20 for the light source 10, and optics 30 for the light source 10. The embodiment also schematically depicts a monolithic body 170 providing the support 140 and the optics 30 (for the light source 10). Embodiments of the invention comprise at least two monolithic bodies 170, each monolithic body 170 comprising at least part of the support 140 and at least part of the optics. Together they provide the combined support and optics body 177.

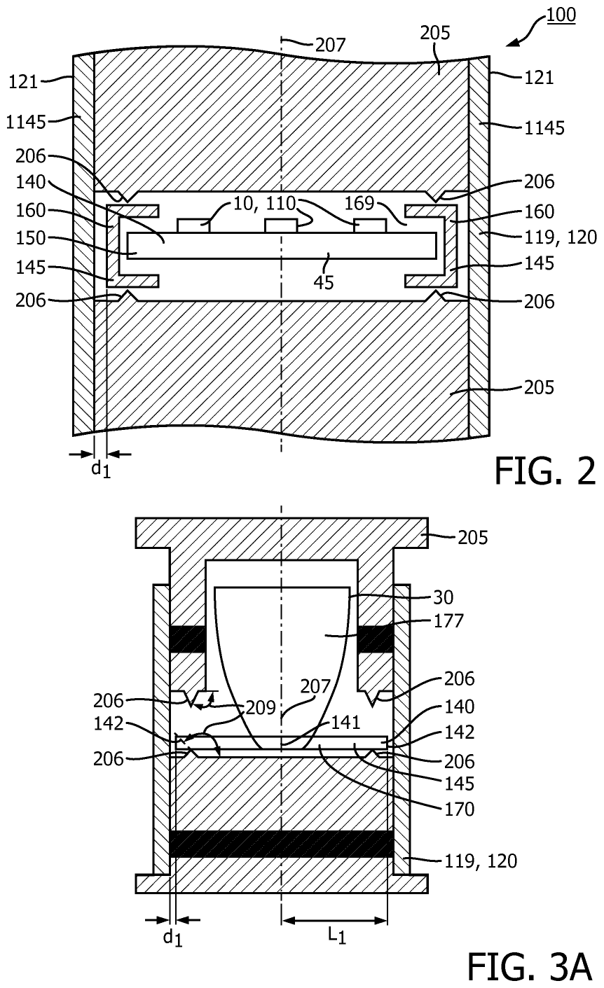

Other embodiments may comprise a support 140 not provided by at least two monolithic bodies 170. Such embodiments not necessarily comprise optics 30, see e.g. FIG. 2.

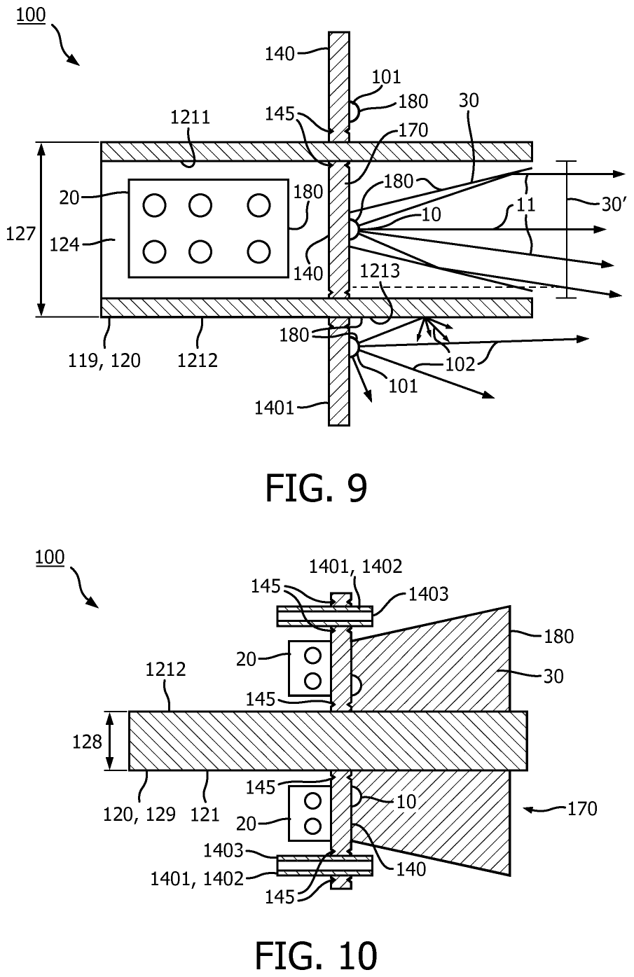

Especially, the one and more monolithic bodies (together) provide the (entire) support and the (entire) optics 30. Especially, the optics 30, provided by the at least two monolithic bodies 170, is functionally coupled to the support 140. Next to the optics 30 (provided by the monolithic bodies 170), embodiments may comprise further optics 30′ (see FIG. 9). Especially, the further optics 30′ may not be functionally be coupled to the support 140. Yet, the further optics 30′ may in embodiments (also) be functionally coupled to the support 140.

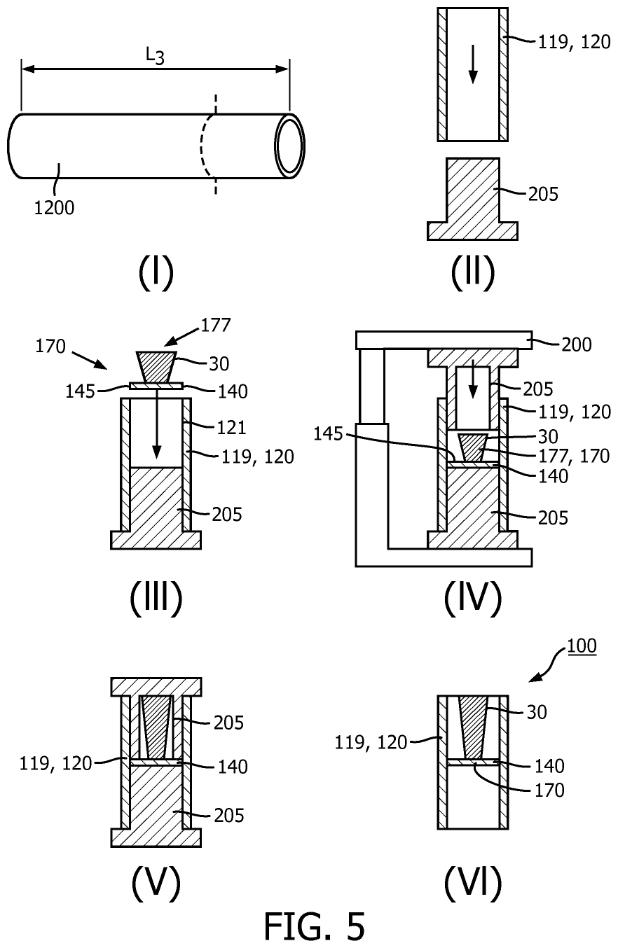

Assembling may be provided according to the process described herein, wherein in an arranging stage the support 140 (in this embodiments provided by the one and more monolithic bodies 170) for the functional element 180 and the functional elements 180 are arranged in the pipe-like shaped element 120,119. It is noted that while arranging the support 140 at the shaped element 120, also the optics 30 may be arranged in or around the shaped element 120 in embodiments comprising a combined support and optics body 177. Especially the optics 30 does not contact the shaped element wall 121 (during or after arranging the optics 30). The support 140 is fastened into the pipe-like shaped element 120,119 by pressing with a pressing element 205 (see FIG. 5) the fastening material 145 against and/or into a pipe-like shaped element wall 121 of the pipe-like shaped element 120. The pipe-like shaped element 120,119 may have an essentially invariable inner diameter 124, at least at and in the direct vicinity of the fixed support 140. Especially, the support 140 does not abut, rest or press upon a (locally) reduced inner diameter portion of the pipe-like shaped element 120,119. In this embodiment the support 140 comprises at least part of the fastening material 145. In other embodiments a support assist 160 (also) comprises at least part of the fastening material 145. In the embodiment in FIG. 2 (see also further below) the support assist 160 comprises a receptor opening 169 configured to receive (at least part of) the support 140 in the pipe-like shaped element 120,119. The process further provides that the functional element 180 and the support 140 are coupled. Especially, the optics 30 and the support are coupled by the at least two monolithic bodies 170. Also further another functional element 180 may be coupled with the support 140. However it is not required that all functional elements 180 are coupled with the support 140. In embodiments (some) functional elements 180 are not (physically) be coupled with the support 140.

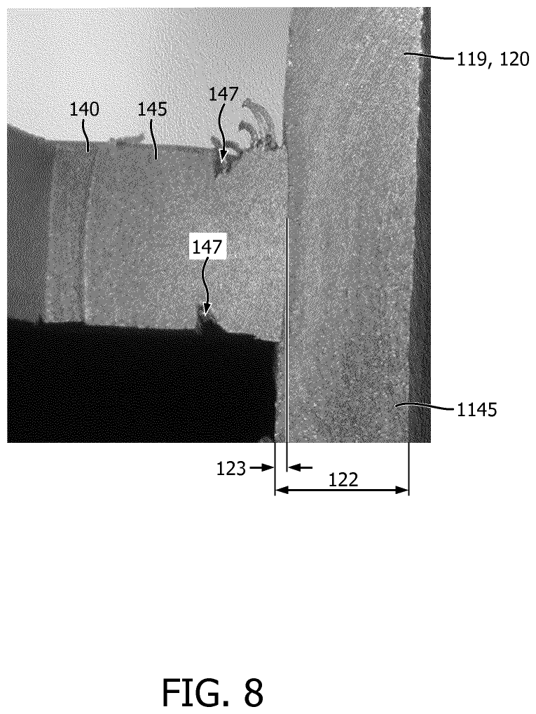

In FIG. 1B schematically an enlarged section of the fastened support 140 protruded in the pipe-like shape element wall 121 is depicted (see also FIG. 8 below showing a picture of such a section). Especially the indentations 147 provided by the pressing element 205, especially the shapes 206 of the pressing element 205 may be observed in the fastening material 145 at a location adjacent to the pipe-like shaped wall 121. The indentations 147 may be continuous and fully circumferential, but alternatively may be an interrupted plurality of circumferentially, (preferably evenly) arranged indentations 147. The support 140 is protruded into wall 121 over a protrusion distance 123. Especially, the pressing element 205, pressure, and pipe-like shaped element 120,119 (and/or in further embodiments, the rod-like shaped element 120, 129) are selected to prevent pressing of fastening material 145 through the pipe-like shaped element wall 121. Hence the protrusion distance 123 is especially smaller than the thickness 122 of the wall 121 of the pipe-like shaped element 120,119.

In FIG. 2 aspects of an embodiment of the lighting device element 100 (before pressing) are schematically depicted. This embodiment comprises a support assist 160 provided with a receptor opening 169 for the support 140. The clearance between the support assist 160 and the pipe-liked shaped wall 121 is indicated by dl. In the embodiment, the support 140 comprises the light source 10, especially a solid state lighting device 110, such as an LED. The light source 10 is arranged at the support 140, especially on a metal core PCB 150. Schematically the pressing element 205 comprising one or more shapes 206 are depicted inside the pipe-like shaped element 120,119. The pipe-liked shaped element wall 121 comprises a wall material 1145. The wall material 1145 may especially be a thermally conductive wall material 1145 to provide a heat sink. Especially, the support assist 160 comprises fastening material 145. The shapes 206 of the pressing element 205 are configured to press the fastening material 145 in an outward direction relative to a central axis 207 of the pressing element 205. Hence, by pressing with the pressing elements 205 the fastening material 145 will be pressed against or into the pipe-like shaped element wall 121. Pressing will also fasten the support 140 in the support assist 160.

The support 140, the support assist 160 and the wall material 1145 (as well as the optics 30 in other embodiments) may comprise thermally conductive material to advance a heat transport from the light source 10 to the surroundings of the lighting device element 100. Especially coefficient of thermal expansion of the wall material 1145 may be selected to be equal to or smaller than the coefficient of thermal expansion of (the material of) the support assist 145 and (of the material) of the support 140. For instance, the coefficient of thermal expansion of the wall material 1145 may be 90%-100% of the coefficient of thermal expansion of the (material of the) support 140 and/or the support assist 160.

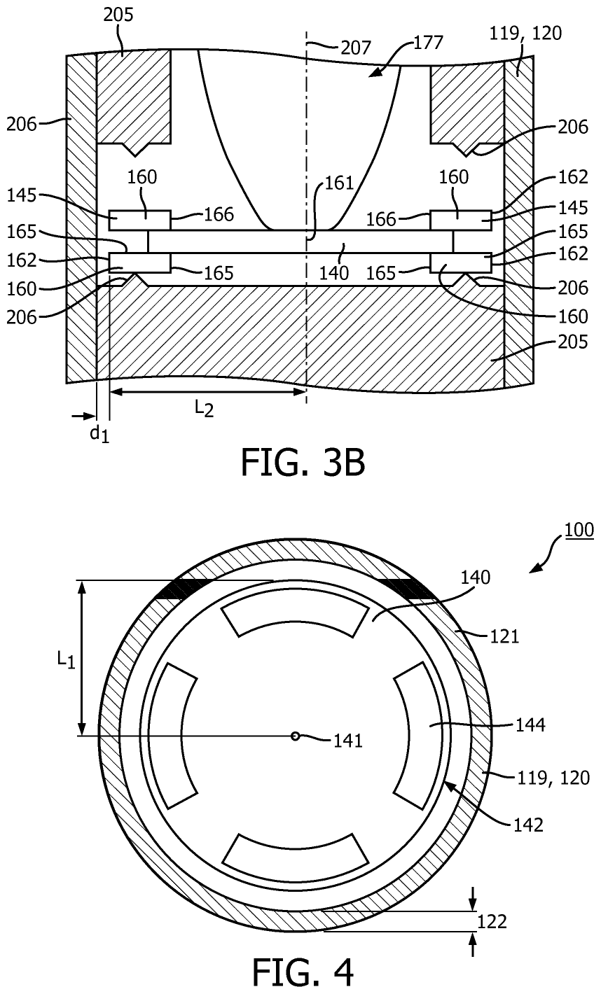

FIGS. 3A and 3B schematically show embodiments of the process for production of the lighting device element 100. In FIG. 3A, a support 140 is pressed, whereas in FIG. 3b the fastening material 145 of a support assist 160 is pressed with a pressing element 205 comprising shapes 206.

In the embodiment depicted in FIG. 3A the support 140 comprises a central point 141 and a perimeter 142 with a maximum length L1 between the central point 141 and the perimeter 142 of the support 140. In this embodiment the process comprises pressing with the pressing element 205 the fastening material 145 at the periphery of the support 140. More especially at a distance from the central point 141 of at least 90% of the maximum length L1. The clearance between the support 140 and the pipe-liked shaped wall 121 is indicated by d1

The geometry of the shapes 206, is specifically shaped to push away material 145 from the peripheral of the support 140 (and/or or the support assist 160) towards the pipe-like shaped element wall 121(, especially while not negatively affecting (contacting) the optics 30). For instance a larger slope 209 of the shape 206 may push more material 145 in the intended direction. By pushing the material 145 in the intended direction the diameter of the support 140 and/or the support assist 160 may increase in such a way that the support 140 is connecting in a mechanical (and in embodiments especially a thermal way). Initial measurements show that a thermal good connection is established with only a 5% thermal system resistance, which is considered to be a very good thermal connection. The central part of the support 140 does not require pressure; only a local deformation close to the periphery of the support 140 may be required. Especially the shape of the pressing element 205 is configured to only provide a pressure at the periphery of the support 140. Hence, the center area of the support 140 may not be deformed during pressing. Therefore, interference with the optics 30, the fixation geometry of optionally comprised LED(s) 10 and/or the flatness of a thermal interface to optional electronics 20 for the light source 10, such as a LED module may be prevented. This allows the use of e.g. a hollow (or open in the middle) pressure element 205 that enables a full assembly of a heat-spreader, comprising e.g. more than one monolithic bodies 170 (also providing the optics 30 for the light source 10), a light source 10, electronics 20 for the light source 10 be preassembled on the support 140, and as a full subassembly to be arranged in the pipe-like shaped element 120,119, wherein the (hollow) pressure element 205 only deforms the peripheral edges of the heat-spreader, i.e. the support 140 and/or the support assist 160. This allows a well accessible and optimized (late stage configuration) production process.

It is further noted that one of the pressure elements 205 further may be configured to hold the support 140 (and/or the combined support and optics 177) before arranging the support 140 in the pipe-like shaped element 120,119. Using such configuration may facilitate positioning the support 140 before pressing at the wall 121. Said pressure element may e.g. comprise holding elements that may be released after pressing the fastening material 145 at the wall 121.

The deformation area in the peripheral of the support 140 or the support assist 160, can be a continuous line, parted line or in any dotted pattern of local deformations.

FIG. 3B schematically depicts above described concept, using a support assist 160 and a support 140 instead of only using a support 140. Because FIG. 3B comprises a cross section, in the embodiment depicted in the figure the support assist 160 is schematically depicted by 4 parts indicated by numbers 165 and 166. However, the parts indicated by reference number 165 especially are connected and form a unity 165. The same holds for the two parts 166, they also make up a second part 166 of the support assist 160. Hence, like the support 140, the support assist 160 also comprises a central point 161 and a perimeter 162 having a maximum length L2 between the central point 161 and the perimeter 162. In this embodiment the process comprises pressing with the pressing element 205 the fastening material 145 that is configured at the periphery of the support assist 160. More especially at a distance from the central point 161 of at least 90% of the maximum length L2.

Again, in both embodiments, the shapes 206 of the pressing element 205 are configured to press the fastening material 145 in an outward direction relative to a central axis 207 of the pressing element 205. Again, in both embodiments, the support 140 is provided by at least two monolithic bodies 170. Likewise the optics 30 is provided by the at least two monolithic bodies 170. Especially, the embodiments comprise a combined support and optics body 177.

FIG. 4 schematically depicts a top view of a support 140 arranged in a pipe like-shape element 120,119, having wall 121 with thickness 122, before pressing and may be comparable to the embodiment depicted in FIG. 3A (without the press element 205), however not comprising the optics 30 (or the combined support and optics body 177). The support 140 comprises elongated through holes 144 that may allow an enhanced heat transport (especially by convection) through the lighting device element 100 (after assembling). Further, the central point 141 of the support 140, the perimeter 142 of the support 140 and the maximum length L1 between the central point 141 and the perimeter 142 are depicted. Through holes 144 may also be used for configuration of electrical wiring.

FIG. 4 schematically depicts an embodiment wherein the internal shape has a circular cross-section and the outer shape has a circular cross-section. Note however that these may differ. For instance, the internal cross-section may be circular, as schematically depicted in FIG. 4, but the external cross-section may be square or may have any other kind of shape.

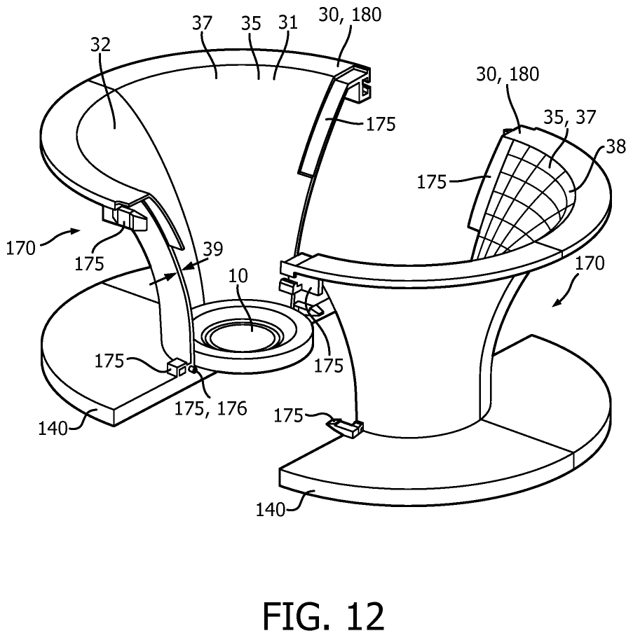

For clarity reasons, FIG. 5 very schematically depicts the concepts of an embodiment of the process for producing a lighting device element 100, especially focusing on the pressing; elements not depicted in this figure are depicted in the other figures. In stage I, a pipe-like shaped element 120,119 is selected from a set of one or more pipe-like shaped elements 1200 having a predetermined length L3, and the length L3 is reduced to a desired length preceding the arranging stage. Here, by way of example the pipe-like shaped element has a circular internal and external cross-section; the pipe-like shaped element is here a tube or tubular shaped element. In stage II, a pressing element 205 is arranged in the pipe-like shaped element 120,119 and a support 140, is arranged in the pipe-like shaped element 120,119 (stage III). In the depicted embodiment, the support 140 (already comprises optics 30. This support 140 is provided by the at least two monolithic bodies 170. In this embodiment, the combined support and optics 177 comprises the support 140. In other embodiments, (only) a support 140, not comprising functional elements 180 yet is arranged in the pipe-like shaped element 120,199. Next (stage IV), the support 140, especially the fastening material 145, of the support 140 is pressed using a pressing system 200, and successively in stage IV the support 140 is fastened in the pipe-like shaped element 120,119. Optionally, a surface of the shaped element wall 121 roughened before stage I, e.g. by means of knurling. After removal of the pressure elements 205, (further) functional elements 180, such as a light source 10 and/or electronics 20 for a light source 10 and/or (further) optics for a light source 10 may be arranged in the pipe-like shaped element 120,119. Optionally, the support 140 already may comprise the light source 10 or other functional elements 180. After arranging the support 140 and the (further) functional elements 180 in the pipe-like shaped element 120,119, the functional element(s) 180 and the support 140 are coupled, providing the lighting device element 100 (not shown in the figure). It is further noted that the support 140 (and the optics 30 for the light source light 10) is provided by at least two monolithic bodies 170 (see also FIG. 12), and the at least two monolithic bodies 170 are connected by connecting elements 175 before fastening the support 140 in the pipe-like shaped element 120,119.

Advantages of the process are e.g.: cold forming of the edge of a part (140, 160) in order to fix it (140, 160) in a pipe-like shaped element 120,119; created contact between the parts 120, 140, 160 and parts 140 and 30 to have a thermal path from heat spreader, i.e. the support 140 and the optional support assist 160, to the heatsink, i.e. the pipe-like shaped element 120,119 and optionally the optics 30; use of the created contact between the parts 140, 120,119 to have a mechanical fixation; optionally a simplified assembly sequence meaning adding the pipe-like shaped element 120,119 as the last part; logistical optimization, less stock, reduction of obsolete stock; low investment cost.

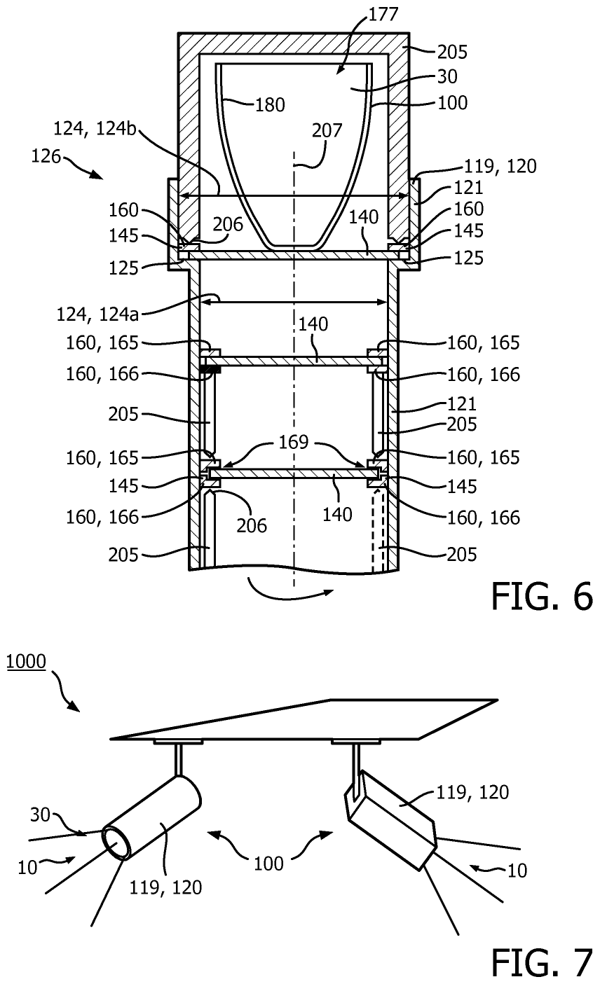

FIG. 6 schematically depicts some embodiments of the arranging stage. The embodiments may depict several different embodiments. The embodiment schematically depicts three supports 140; of which (the top) one support 140 comprises is provided by at least two monolithic bodies 170 (and hence comprising the optics 30 for a light source 10. The other supports 140 are depicted to further explain the options of the process for fastening a support 140 at a shaped element 120. In an embodiment the lighting device element 100 may comprise e.g. at least one of these supports 140. For instance, the middle support 140 and the bottom support 140 as depicted in the figure may be provided in the same lighting device element 100. In other embodiments, the top support 140 and the bottom support 140 may be provided in the same lighting device element 100, see further below.

At the top of the figure a pipe-like shaped element 120,119 comprising a restriction or rest 125 in the cross section or diameter 124 of the pipe-like shaped element 120,119 is depicted, i.e. there the inner diameter 124 of the pipe-like shaped element (locally) is not constant, i.e. at or in the direct vicinity of a support 140 the inner diameter 124 varies from a relatively small diameter 124a to a relatively large diameter 124b. A support 140 (or a support assist 160), in the embodiment being part of the combined support and optics 177, may be arranged on the rest 125, and pressing may provide a fastening of the support 140 (or the support assist 160) (fastening material 145) against or into the pipe-like shaped element wall 121.

In the middle of the figure, a support 140 received in a support assist 160 is depicted, wherein the support assist comprises two parts 165, 166.

At the bottom also a support 140 in a support assist 160 is depicted. Of course, the order of the supports 140 may also be selected differently.

The support 140 may be fastened by pressing with the pressing element 205. Especially, the pipe-like shaped element 120,119 may comprise a circular cross-section. To fasten the support 140, the invention provides in different embodiments that pressure can be applied in a point, partial trajectory or a line fully around the periphery of the support 140 and/or the support assist 160. In the depicted embodiment the pressing element 205 comprises a position where it may contact one part 166 of the support assist 160 (the schematically depicted other position of the pressing element 205 is shown in phantom lines to illustrate an alternative position). Especially pressing may be applied at multiple points of the support assist 160. The pressing element 205 may rotate around the center axis 207 of the pressing element 205, (especially the center axis 207 of the positions of the pressing element 205 during successive pressing actions) and press material 145 in an outward direction relative to a central axis 207 to fasten the support 140 in the support assist 160 and to fasten the support assist 160 against or into the pipe-like shaped wall 121. In embodiments, one of the elements 205 is configured with holding elements and the support 140 may be held by (removable) holding elements, to position the support before and during the application of pressure.

Especially, for providing the middle support 140 and the bottom support 140 in one device element 100, the middle support 140 may be provided first. Next, the bottom support 140 may be provided, after arranging a pressing element 205 (or optionally two or more pressing elements 205) between the middle support 140 and the bottom support 140. In other embodiments the second part 166 of the support assist 160 located at the middle support 140 may comprise the pressing element 205. Especially in such embodiments pressing may provide fastening the middle support 140 and the bottom support 140 in one pressing action. For instance in this way, more than one support and/or support assist may be configured within the pipe-like shaped element 120,119. The fixed middle support 140 and the bottom support 140 and the pipe-like shaped element 120,119 together form a gastight chamber 126 when the fixation of the support is fully circumferential, which is obtained by the use of fully circumferential pressing elements 205. In said gastight chamber 126 oxidation sensitive elements may be accommodated. Note that the length of the pressing elements 205 located in the chamber 126 may be tailor made to set the length/size of the chamber. The terms “middle support” or “support in the middle” may also refer to a plurality of middle supports.

FIG. 7 schematically depicts an embodiment of a lighting device 1000 as described herein, here comprising a plurality of pipe-like shaped elements 120,119. Both lighting device elements 100 comprising a pipe-like shaped element 120,119 and a light source 10 and optics 30 for the light source 10. Especially, both lighting device elements 100 comprise at least two monolithic bodies 170 (not shown). The lighting device 1000 is assembled from the two lighting device elements 100 and some other elements, such as hinges and a central plate for mounting the lighting device 1000. In this embodiment one lighting device element 100 comprises a pipe-like shaped element 120,119 comprising a circular cross-section, while the other lighting device element 100 comprises a squared cross-section. In other embodiments, the lighting device elements 100 comprise other types of cross-sections. Here, the right lighting device element 100 is especially depicted to indicate a pipe-like shaped element 120,119 having a square internal cross-section (and a square external cross-section). Note however that optionally the right lighting device element 100 may alternatively have a circular (or other) shaped internal cross-section.

In FIG. 8 a photograph of an embodiment is given showing the support 140 fastened to the pipe-like shaped element 120,119. Pressing the fastening material 145 hereby resulted in the indentation 147 and the protrusion of the support 140 over a protrusion distance 123 in the wall material 1145 of the pipe-like shaped element 120,119. Especially, the protrusion distance 123 is smaller than the thickness 122 of the wall of the pipe-type shaped element 120.

FIG. 9. Schematically depicts some further aspects of an embodiment of the lighting device element 100. The lighting device element 100 schematically depicted in FIG. 9, comprises a pipe-like shaped element 120,119 and various functional elements 180, i.e., a light source 10, an additional light source 101, electronics 20 for the light source 10 and 101, optics 30 for the light source 10, and a diffuse reflective coating 1213 for the light source 101. Not only a support 140 (optionally provided by the at least two monolithic elements 170) is fastened into the pipe-like shaped element 120,119 at its inner wall surface 1211, but further a support 140 is also fastened around the pipe-like shaped element at the outer wall surface 1212 of the pipe-like shaped element. Both supports 140 are fastened by pressing with a pressing element 205 (see FIG. 5) the fastening material 145 against and/or into a pipe-like shaped element wall 121 of the pipe-like shaped element 120,119. On the support 140 fastened to the outer wall surface an additional light source 101 is mounted, which outer support 140 simultaneously functions as a heat sink 1401 by being shaped as a fin extending radially form the pipe-like shaped element, which fin shape is a cooling feature of the heat sink. During operation the light source 10 typically provides a narrow light beam 11, that may be directed by the optic 30 for the light source light 10, and the additional light source 101 provides a relatively wide beam 102. The combination of the light source 10 and the additional light source 101 can provide an attractive light pattern of a narrow beam surrounded by a diffuse halo of lower intensity and different color or color temperature. To enhance the diffusiveness of the halo the outer wall surface 1212 is (locally) provided with a highly diffuse reflective coating 1213. The pipe-like shaped element 120,119 has an essentially invariable inner diameter 124 and invariable outer diameter 127, at least at and in the direct vicinity of the fixed support 140, in particular the support 140 does not abut, rest or press upon a (locally) reduced inner diameter portion of the pipe-like shaped element 120. In this embodiment both supports 140 comprise at least part of the fastening material 145. In this embodiments also further optics 30′ are depicted. Especially, the further optics 30′, e.g. louvres in front of the light, may not be functionally coupled to the support 140. However, the further optics 30′ may in embodiments (also) be functionally coupled to the support 140, schematically indicated by the dotted connection line. Especially, the functional elements 180 are coupled to a support 140. Especially further functional elements such as the further optics 30′may not be coupled to a support 140.

FIG. 10 schematically depicts some further aspects of an embodiment of the lighting device element. The lighting device element 100 schematically depicted in FIG. 10, comprises as a shaped element 120 a rod-like shaped element 129 with an outer diameter 128, and various functional elements 180, i.e., a light source 10, electronics 20 for the light source 10, optics 30 or the light source 10, and a heat sink 1401 for the light source 10. Again, the support 140 and the optics for the light source 10 are provided by at least two monolithic bodies 170. However in other embodiments, the optics 30 may also be provided to the support 140 after fastening the support 140 to the rod-like shapes element 120,129. A support 140 is fastened to the rod-like shaped element 120,129 at its outer wall surface 1212 of the rod-like shaped element. The support 140 is fastened by pressing with a pressing element 205 (see FIG. 5) the fastening material 145 against and/or into a rod-like shaped element wall 121 of the rod-like shaped element 120,129. The heat sink 1401 comprises a plurality of pipes as a cooling feature 1402 which are fastened in openings of the support 140 by pressing with a pressing element 205 (see FIG. 5) the fastening material 145 against and/or into pipe wall 1403 of the pipes 1402, i.e. similar to the way of fastening the support to the rod-like shaped element.

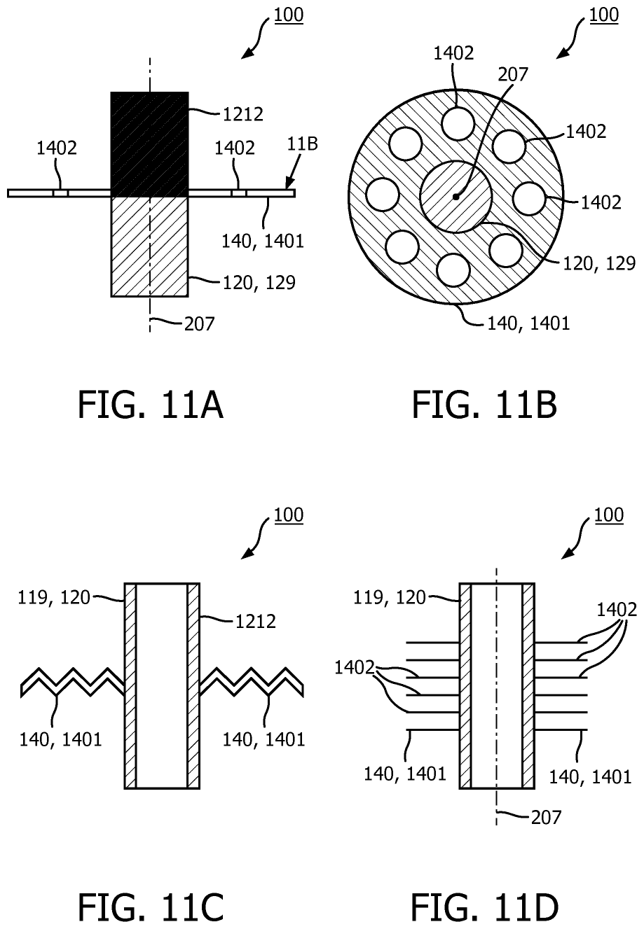

FIGS. 11A-D schematically depict some further aspects of further embodiments of the lighting device element 100. FIG. 11A shows cross-sectional view and FIG. 11B shows a top view of a rod-like shaped element 120,129 with a support fastened 140 to the outer wall surface 1212 and radially extending outwards away from the central axis 207. It is noted that to explain these aspects, the optics 30 for a light source light 10 and e.g. an optional light source 10 are not depicted in the figures. Embodiments comprising these aspects, however may also comprise the combined support and optics 177, and therefore optics 30 for a light source 10 if the support 140 is provided by at least two monolithic bodies 170.

The support 140 acts as a heat sink 1401 and has as cooling feature 1402 a plurality of circular openings, see FIG. 11B. FIG. 11C shows cross-sectional view of a lighting device element 100 comprising a pipe-like shaped element 120,119 with a support 140 fastened to the outer wall surface 1212. The support acts as a heat sink 1401 and has as cooling feature 1402 an embossing. FIG. 11D shows cross-sectional view of a lighting device element 100 comprising a pipe-like shaped element 120,119 with a support 140 fastened to the outer wall surface 1212. The support 140 acts as a heat sink 1401 and has as cooling feature 1402 a plurality of fins radially extending outwards, away from the central axis 207.

FIG. 12 schematically depicts four monolithic bodies 170, already assembled in two identical pairs, that when being mutually connected provide the support 140 and the optics 30 for the light source 10 (and the combined support and optics 177). Especially, all four monolithic bodies 170 comprise (at least) part of the support 140 and (at least part of) the optics 30 for the light source 10. The (parts of the) optics 30 comprises a reflector 35, especially comprising a reflective surface 37. In the embodiment, the optics 30 further comprises a polished surface 31, especially to enhance reflection of light. In the same figure also optics 30 further comprising a coating 32, especially to affect the light is depicted. The embodiment further depicts the reflective surface 37 comprising facets 38. In embodiments, especially either a coating 32, or another type of reflection enhancer may be present. A coating 32 and, e.g., (polished) facets 38, however, may also be present in the same embodiment. The monolithic bodies 170 may especially be provided by thixomolding, especially allowing providing complex structures comprising thin elements. In embodiments, e.g. the optics 30 comprises a thickness 39 selected in the range of 0.1-5 mm.

The four monolithic bodies may be connected by one or more connecting elements 175, such as slotted spring pins 176. In other embodiments, connecting elements 175 may comprise different elements known in the art to connect different element, e.g., dovetail joints. Especially, after physically connecting the monolithic bodies 170 the monolithic bodies mutually contact each other, and especially a combined support and optics 177 may be provided.

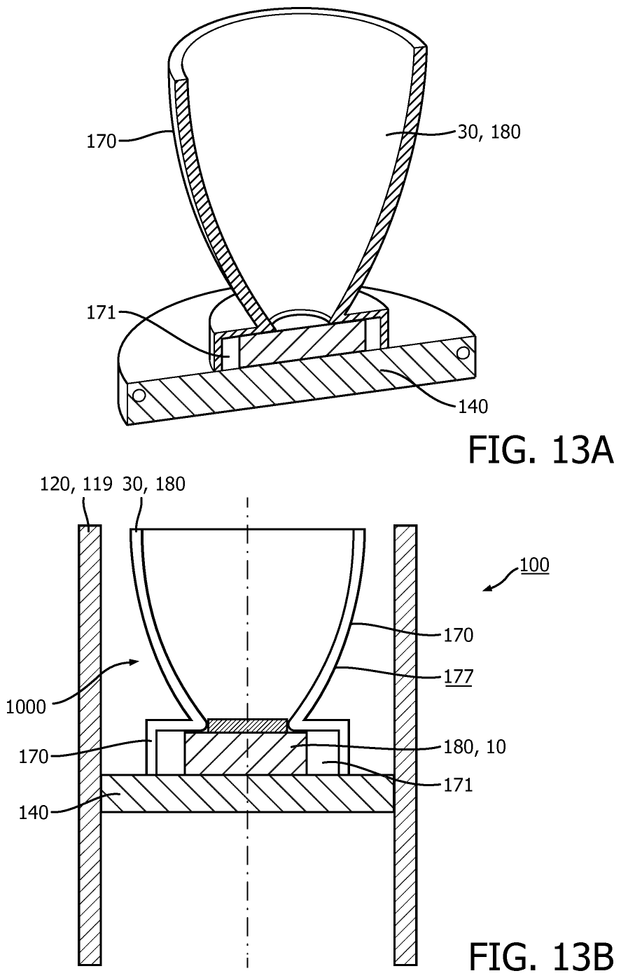

FIG. 13A-B respectively show a perspective view of one of the two monolithic bodies 170 and a cross sectional view of a lighting device element 100 comprising a lighting device 1000 and a pipe-like shaped element 120,119. Said monolithic bodies 170 provide the support 140 and the optics 30 for the light source 10 (and the combined support and optics 177). The monolithic body 170 has a form-factor such that in assembled configuration with its counterpart monolithic body, a form-fitting cavity 171 is formed for accommodating and fixing at least one functional element 180, i.e. a COB light source as shown in FIG. 13B. The form factor is such that the functional element 180 accommodated in once joined at least two monolithic bodies 170, can only be released from the form-fitting cavity 171 upon disassembling the joined at least two monolithic bodies 170.

The term “substantially” herein, such as in “substantially all light” or in “substantially consists”, will be understood by the person skilled in the art. The term “substantially” may also include embodiments with “entirely”, “completely”, “all”, etc.

Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lighting device element comprising (i) at least one shaped element selected from the group consisting of a pipe-like shaped element and a rod-like shaped element, (ii) one or more functional elements selected from the group consisting of a light source, electronics for a light source, a heat sink and optics for a light source, and (iii) a support for the one or more functional elements, wherein the lighting device element comprises at least said optics as functional element, wherein the lighting device element comprises at least two monolithic bodies, each monolithic body comprising at least part of the support and at least part of the optics, with said at least two monolithic bodies providing thereby said support and said optics, wherein (a1) at least part of the support and (a2) at least part of the one or more functional elements are accommodated within and/or around the shaped element; wherein the support and the one or more functional elements are coupled; wherein (b1) the support comprises at least part of a fastening material and/or (b2) a support assist, at least partly configured within and/or around the shaped element, comprises at least part of the fastening material and the support assist comprises a receptor opening hosting at least part of the support; wherein adjacent to a shaped element wall of the shaped element the fastening material comprises (c1) an indentation and (c2) part of the fastening material is in pressed physical contact with said shaped element wall and/or protruding into said shaped element wall via which the support is locally fixed to the shaped element,
wherein at least one of the monolithic bodies is in contact with another of the monolithic bodies and in assembled position the optics is formed by the at least two monolithic bodies.

2. The lighting device element according to claim 1, wherein the at least two monolithic bodies both have a form-factor such that in assembled a form-fitting cavity is formed for accommodating and fixing at least one functional element.

3. The lighting device element according to claim 1, wherein the at least two monolithic bodies have identical shapes.

4. The lighting device element according to claim 1, wherein the lighting device element further comprises a connecting element, wherein the connecting element physically connect the monolithic bodies.

5. The lighting device element according to claim 1, wherein the at least two monolithic bodies comprise a magnesium alloy.

6. The lighting device element according to claim 1, wherein the at least two monolithic bodies comprise a thixomolded monolithic body.

7. The lighting device element according to claim 1, wherein the optics comprises a reflector.

8. The lighting device element according to claim 1, wherein the optics comprise a thickness selected in the range of 0.1 mm-5 mm.

9. The lighting device element according to claim 1. wherein the lighting device element at least comprises said light source.

10. The lighting device element according to claim 1, wherein the shaped element is selected from the group consisting of a pipe-like shaped element having an inner diameter and an outer diameter and a rod-like shaped element having a rod outer diameter, and wherein at least locally the inner diameter and/or outer diameter is essentially invariable.

11. The lighting device element according to claim 1, wherein part of the fastening material is in pressed physical contact with the shaped element wall of the shaped element and/or protruding into said shaped element wall via continuous or via line/point protrusions extending over at least half of the circumference of said wall.

12. A lighting device comprising the lighting device element according to claim 1, the lighting device comprising the shaped element, the light source, electronics for the light source, optics for the light source, and the support and optionally a heat sink and one or more other elements, wherein the light source, the electronics for the light source, the support, the optics for the light source, the optional heat sink and the optional one or more other elements, are coupled to the lighting device.

13. A process for the production of a lighting device element, the lighting device element comprising (i) at least one shaped element selected from the group consisting of a pipe-like shaped element and a rod-like shaped element and (ii) one or more functional elements selected from the group consisting of a light source, electronics for a light source, a heat sink, and optics for a light source, and (iii) a support for the one or more functional elements, wherein the lighting device element comprises at least said optics as functional element, wherein the lighting device element comprises at least two monolithic bodies, each monolithic body comprising at least part of the support and at least part of the optics, with said at least two monolithic bodies providing thereby said support and said optics, the process comprising an arranging stage, the arranging stage comprising:
arranging in and/or around the shaped element (a1) at least part of the support of said at least two monolithic bodies fastening the support to at least part of the shaped element by pressing with a pressing element a fastening material against and/or into a shaped element wall of the shaped element; and coupling one or more optional functional elements other than the optics and the support;
wherein (b1) the support comprises at least part of the fastening material and/or (b2) a support assist, at least partly configured within or around the shaped element, comprises at least part of the fastening material and the support assist comprises a receptor opening configured to receive at least part of the support, wherein the process further comprises (i) associating the one or more functional elements other than the optics with at least one of said monolithic bodies, and (ii) physically coupling the at least two monolithic bodies, wherein the shaped element comprises a pipe-like shaped element the process further comprising roughening at least part of the shaped wall element wall before pressing with a pressing element the fastening material against and/or into the shaped element wall.

14. The process according to claim 13, wherein the shaped element is selected from the group consisting of a pipe-like shaped element having an inner diameter and an outer diameter and a rod-like shaped element having a rod outer diameter, and wherein the arranging stage comprises: arranging in and/or around the shaped element where at least locally said inner diameter and/or said outer diameter is essentially invariable (a1) at least part of a support of said at least two monolithic bodies, fastening the support to the at least part of the shaped element by pressing with a pressing element a fastening material against and/or into a shaped element wall of the shaped element; and coupling one or more optional functional elements other than the optics and the support.

15. A process for the production of a lighting device, the lighting device comprising a lighting device element comprising at least one shaped element selected from the group consisting of a pipe-like shaped element and a rod-like shaped element, and a light source, the lighting device further comprising electronics for the light source, and optics for the light source, wherein the process comprises assembling the shaped element, the light source, the electronics, the optics, and optionally a heat sink and one or more other elements, to the lighting device while assembling the lighting device element according to the process according to claim 13.
